(19) United States
(12) Patent Application Publication
(10) Pub. No.: US 2019/0101926 A1
(43) Pub. Date: Apr. 4, 2019

(54) AUTONOMOUS MOBILE CLEANING APPARATUS, CLEANING METHOD, AND RECORDING MEDIUM

(71) Applicant: Panasonic Intellectual Property Management Co., Ltd., Osaka (JP)

(72) Inventors: YUKI TAKAOKA, Osaka (JP); TOMOHITO OOHASHI, Osaka (JP); KAZUYOSHI MORITANI, Osaka (JP); YUKO TSUSAKA, Osaka (JP)

(21) Appl. No.: 16/135,334

(22) Filed: Sep. 19, 2018

(30) Foreign Application Priority Data
Sep. 29, 2017 (JP) 2017-191438
Mar. 29, 2018 (JP) 2018-065568

(51) Int. Cl. G05D 1/02; A47L 11/40; G05D 1/00

(52) U.S. Cl. CPC G05D 1/0238; A47L 11/4061; G05D 1/0088; G05D 2201/0203; G05D 1/0274; A47L 2201/04; G05D 2201/0215; G05D 1/0246

(57) ABSTRACT

There is provided an autonomous mobile cleaning apparatus including a controller. The controller obtains information about a first target object having a possibility of putting a main body into a stuck state. After accepting information indicating that the first target object is to be set as a cleaning target object, the controller causes a display to display a first display screen that allows selection of a first movement mode or a second movement mode. The autonomous mobile cleaning apparatus is caused to climb over the first target object in a first process, and caused to clean a first area except for the first target object in a second process. The second process is performed prior to the first process in the first movement mode, and the first process is performed prior to the second process in the second movement mode.

### BACKGROUND

### 1. Technical Field

The present disclosure relates to an autonomous mobile cleaning apparatus, a cleaning method, and a recording medium.

### 2. Description of the Related Art

Japanese Unexamined Patent Application Publication No. 2006-277121 discloses a movement path creation apparatus that creates a movement path in accordance with a movement area. Specifically, the movement path creation apparatus creates a movement path using information about an area across which a mobile robot is unable to move.

### SUMMARY

Japanese Unexamined Patent Application Publication No. 2006-277121 discloses the technique for creating a movement path using information about an area across which the mobile robot is unable to move.

However, a technique for creating a movement path by taking into consideration a course of movement to an area in which the mobile robot has difficulty in moving is not disclosed.

One non-limiting and exemplary embodiment provides an autonomous mobile cleaning apparatus, a cleaning method, and a recording medium with which movement modes that take into consideration the order of cleaning of a target object having a possibility of creating a stuck state and cleaning of a portion other than the target object can be generated and provided to a user.

In one general aspect, the techniques disclosed here feature an autonomous mobile cleaning apparatus including: a main body; a suction unit included in the main body; a driver included in the main body and driving movement of the main body; a controller included in the main body; and a display included in the main body. The controller (a) obtains information about a first target object having a possibility of putting the main body into a stuck state, and the controller (b) accepts information indicating that the first target object is to be set as a cleaning target object, and thereafter, causes the display to display a first display screen that allows selection of a first movement mode or a second movement mode. The autonomous mobile cleaning apparatus is caused to climb over the first target object in a first process, the autonomous mobile cleaning apparatus is caused to clean a first area except for the first target object in a second process, the second process is performed prior to the first process in the first movement mode, and the first process is performed prior to the second process in the second movement mode.

According to the present disclosure, movement modes that take into consideration the order of cleaning of a target object having a possibility of creating a stuck state and cleaning of a portion other than the target object can be generated and provided to a user.

It should be noted that general or specific embodiments may be implemented as a system, a method, an integrated circuit, a computer program, a computer-readable recording medium, or any selective combination thereof. Examples of a computer-readable recording medium include a non-volatile recording medium, such as a compact disc read-only memory (CD-ROM).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a plan view of an autonomous mobile cleaning apparatus according to a first embodiment of the present disclosure;

FIG. 2 is a bottom view of the cleaning apparatus illustrated in FIG. 1;

FIG. 3 is a front view of the cleaning apparatus illustrated in FIG. 1;

FIG. 4 is a side view of the cleaning apparatus illustrated in FIG. 1;

FIG. 5 is a functional block diagram of the cleaning apparatus illustrated in FIG. 1;

FIG. 6 is a block diagram of a sensor unit and so on of the cleaning apparatus illustrated in FIG. 1;

FIG. 7A is a plan view illustrating a state where the cleaning apparatus moves in a direction orthogonal to an edge of a target object, such as a long-pile rug, at time t1, the target object being placed on a floor so as to be relatively movable;

FIG. 7B is a plan view illustrating a state where the cleaning apparatus is stuck at the edge of the target object at time t2 after the state illustrated in FIG. 7A;

FIG. 7C is a view illustrating the state where the cleaning apparatus is stuck, as illustrated in FIG. 7B, when viewed from diagonally above a side of the cleaning apparatus;

FIG. 7D is a plan view illustrating a state where the cleaning apparatus moves in a direction diagonal to the edge of the target object illustrated in FIG. 7A to avoid the stuck state;

FIG. 7E is a plan view illustrating a state where the cleaning apparatus moves over the edge of the target object after the state illustrated in FIG. 7D;

FIG. 8A is a plan view illustrating a state where the cleaning apparatus moves in a direction orthogonal to an edge of a target object, such as interlocking foam mats, that is placed on a floor so as to be relatively movable;

FIG. 8B is a view illustrating a state where the cleaning apparatus is stuck at the edge of the target object after the state illustrated in FIG. 8A when viewed diagonally upward from below a side of the cleaning apparatus;

FIG. 8C is a plan view illustrating a state where the cleaning apparatus moves in a direction diagonal to the edge of the target object illustrated in FIG. 8A to avoid the stuck state;

FIG. 9 is a diagram illustrating a map including positional relationships of objects and so on located within a cleaning area;

FIG. 10A is a diagram illustrating a display disposed on a cleaning apparatus main body;

FIG. 10B is a diagram illustrating a display disposed on an external terminal, such as a smartphone;

FIG. 11A is a diagram illustrating an example camera image from which information about a chair, which is an example object, is obtained, the image including information about the surroundings of the cleaning apparatus main body;

FIG. 11B is a diagram illustrating an example image, which is a camera image, of the rug, which is an example target object, at time t1;

FIG. 12A is a plan view of a cleaning apparatus according to a first modification of the first embodiment of the present disclosure;

FIG. 12B is a bottom view of the cleaning apparatus according to the first modification;

FIG. 13A is a flowchart illustrating a movement control method for the cleaning apparatus;

FIG. 13B is a diagram illustrating a generated frame-shaped movement path;

FIG. 13C is a diagram illustrating a generated random-shaped movement path;

FIG. 13D is a diagram illustrating a generated spiral movement path;

FIG. 13E is a flowchart illustrating the movement control method including a detailed description of a step of setting a movement path;

FIG. 14A is a diagram illustrating a display screen on a display for prompting a user to select whether to set an object detected by an image processing unit as a cleaning target object and for accepting a selection instruction;

FIG. 14B is a diagram illustrating a display screen on a display for prompting a user to select whether to clean a cleaning target object and for accepting a selection instruction;

FIG. 14C is a diagram illustrating a display screen on a display for prompting a user to select whether to clean a cleaning target object first and for accepting a selection instruction;

FIG. 14D is a diagram illustrating a display screen on a display for prompting a user, when a cleaning target object is to be cleaned, to select A “clean the cleaning target object first” or B “clean the cleaning target object last” and for accepting a selection instruction;

FIG. 14E is a flowchart illustrating steps of a cleaning method that is performed by the cleaning apparatus according to a third modification of the first embodiment;

FIG. 14F is a diagram illustrating a case of cleaning along the frame-shaped movement path illustrated in FIG. 13B in the cleaning area illustrated in FIG. 9;

FIG. 14G is a diagram illustrating a case of cleaning along the random-shaped movement path illustrated in FIG. 13C in the cleaning area illustrated in FIG. 9;

FIG. 14H is a diagram illustrating a case of cleaning along the spiral movement path illustrated in FIG. 13D in the cleaning area illustrated in FIG. 9;

FIG. 15A is a flowchart illustrating minimum-configured steps of the cleaning method that is performed by the cleaning apparatus according to the first embodiment;

FIG. 15B is a flowchart illustrating steps of a cleaning method that is performed by the cleaning apparatus according to a second modification of the first embodiment;

FIG. 15C is a flowchart illustrating a movement control method in a case where the cleaning apparatus enters a stuck state;

FIG. 15D is a diagram illustrating the passage of time in a case where the cleaning apparatus enters a stuck state;

FIG. 15E is a diagram illustrating a display screen on a display for prompting a user, in a step of re-determining a movement mode, to select when to clean a cleaning target object that has created a stuck state and for accepting a selection instruction;

FIG. 16A is a flowchart illustrating example steps from a step of driving the cleaning apparatus main body in the cleaning method that is performed by the cleaning apparatus;

FIG. 16B is a diagram illustrating operation control modes in a case where a cleaning target object that has created a stuck state is to be re-cleaned;

FIG. 16C is a flowchart illustrating example steps from a step of accepting a movement mode in the cleaning method that is performed by the cleaning apparatus;

FIG. 17A is a plan view of a round autonomous mobile cleaning apparatus according to the present disclosure; and

FIG. 17B is a bottom view of the cleaning apparatus illustrated in FIG. 17A.

### DETAILED DESCRIPTION

Hereinafter, embodiments of the present disclosure will be described in detail with reference to the drawings.

### Various Aspects of the Present Disclosure

Before detailed descriptions of embodiments of the present disclosure are given with reference to the drawings, various aspects of the present disclosure are described below.

A first aspect of the present disclosure provides an autonomous mobile cleaning apparatus including: a main body; a suction unit included in the main body; a driver included in the main body and driving movement of the main body; a controller included in the main body; and a display included in the main body. The controller (a) obtains information about a first target object having a possibility of putting the main body into a stuck state, and the controller (b) accepts information indicating that the first target object is to be set as a cleaning target object, and thereafter, causes the display to display a first display screen that allows selection of a first movement mode or a second movement mode. The autonomous mobile cleaning apparatus is caused to climb over the first target object in a first process, the autonomous mobile cleaning apparatus is caused to clean a first area except for the first target object in a second process, the second process is performed prior to the first process in the first movement mode, and the first process is performed prior to the second process in the second movement mode.

According to the first aspect, movement modes that take into consideration the order of cleaning of a target object having a possibility of creating a stuck state and cleaning of a portion other than the target object can be generated and provided to a user.

A second aspect of the present disclosure provides the autonomous mobile cleaning apparatus according to the first aspect, the autonomous mobile cleaning apparatus further including a memory that stores the information about the first target object. In the autonomous mobile cleaning apparatus, the controller obtains the information about the first target object from the memory.

A third aspect of the present disclosure provides the autonomous mobile cleaning apparatus according to the first or second aspect, in which (c) after obtaining the information about the first target object and before accepting the information indicating that the first target object is to be set as a cleaning target object, the controller causes the display to display a second display screen that allows selection of whether to set the first target object as a cleaning target object, and in a state where the second display screen is displayed, the controller accepts information indicating that the first target object is to be set or is not to be set as a cleaning target object.

A fourth aspect of the present disclosure provides the autonomous mobile cleaning apparatus according to the first or second aspect, in which (d1) in a case where the controller accepts selection of the first movement mode in a state where the first display screen is displayed, the controller causes the main body to move in accordance with the first movement mode, and (d2) in a case where the controller accepts selection of the second movement mode in a state where the first display screen is displayed, the controller causes the main body to move in accordance with the second movement mode.

A fifth aspect of the present disclosure provides the autonomous mobile cleaning apparatus according to any one of the first to fourth aspects, the autonomous mobile cleaning apparatus further including a camera included in the main body. In the autonomous mobile cleaning apparatus, the camera obtains a camera image including information about surrounding of the main body, and in (a), the controller obtains the information about the first target object on the basis of the camera image.

A sixth aspect of the present disclosure provides the autonomous mobile cleaning apparatus according to any one of the first to fifth aspects, the autonomous mobile cleaning apparatus further including a first sensor included in the main body. In the autonomous mobile cleaning apparatus, in (a), the controller obtains the information about the first target object on the basis of information about objects detected by the first sensor.

A seventh aspect of the present disclosure provides the autonomous mobile cleaning apparatus according to any one of the first to sixth aspects, the autonomous mobile cleaning apparatus further including a second sensor that detects the stuck state. In the autonomous mobile cleaning apparatus, in (a), the controller obtains the information about the first target object on the basis of information about the stuck state detected by the second sensor.

An eighth aspect of the present disclosure provides the autonomous mobile cleaning apparatus according to any one of the first to sixth aspects, the autonomous mobile cleaning apparatus further including a second sensor that detects the stuck state. In the autonomous mobile cleaning apparatus, (e1) the controller controls the driver to drive the main body on the basis of selection of the second movement mode, and (e2) in a case where the second sensor detects the stuck state, and thereafter, the controller detects the main body exiting the stuck state, the controller changes the second movement mode to the first movement mode and controls the driver to drive the main body.

A ninth aspect of the present disclosure provides the autonomous mobile cleaning apparatus according to any one of the first to sixth aspects, the autonomous mobile cleaning apparatus further including a second sensor that detects the stuck state. In the autonomous mobile cleaning apparatus, (e1) the controller controls the driver to drive the main body on the basis of selection of the second movement mode, and (e2) in a case where the second sensor detects the stuck state, and thereafter, the controller detects the main body exiting the stuck state, the controller causes the display to display the first display screen.

A tenth aspect of the present disclosure provides the autonomous mobile cleaning apparatus according to any one of the first to sixth aspects, the autonomous mobile cleaning apparatus further including a second sensor that detects the stuck state. In the autonomous mobile cleaning apparatus, (f1) the controller accepts selection of the second movement mode in a state where the first display screen is displayed, (f2) the controller selects one operation control mode from among operation control modes as a first operation control mode and controls the driver in accordance with the first operation control mode and the second movement mode to drive the main body, and (f3) in a case where the second sensor detects the stuck state, and thereafter, the controller detects the main body exiting the stuck state, the controller selects an operation control mode different from the first operation control mode as a second operation control mode from among the operation control modes and controls the driver in accordance with the second operation control mode and the second movement mode to drive the main body, and the second operation control mode is different from the first operation control mode in a movement speed, a movement direction, or rotation or stop of a side brush of the main body.

An eleventh aspect of the present disclosure provides the autonomous mobile cleaning apparatus according to the tenth aspect, in which (f4) in a case where the controller drives the main body in accordance with the second operation control mode and the second movement mode, and thereafter, the second sensor detects the stuck state, the controller changes the second movement mode to the first movement mode and controls the driver to drive the main body.

A twelfth aspect of the present disclosure provides a cleaning method for an autonomous mobile cleaning apparatus, the method including: (a) obtaining information about a first target object having a possibility of putting a main body included in the autonomous mobile cleaning apparatus into a stuck state, the main body including a suction unit; and (b) accepting information indicating that the first target object is to be set as a cleaning target object, and thereafter, causing a display included in the autonomous mobile cleaning apparatus to display a first display screen that allows selection of a first movement mode or a second movement mode. The autonomous mobile cleaning apparatus is caused to climb over the first target object in a first process, the autonomous mobile cleaning apparatus is caused to clean a first area except for the first target object in a second process, the second process is performed prior to the first process in the first movement mode, and the first process is performed prior to the second process in the second movement mode.

According to the twelfth aspect, movement modes that take into consideration the order of cleaning of a target object having a possibility of creating a stuck state and cleaning of a portion other than the target object can be generated and provided to a user.

A thirteenth aspect of the present disclosure provides the cleaning method according to the twelfth aspect, in which the information about the first target object is obtained from a memory included in the autonomous mobile cleaning apparatus.

A fourteenth aspect of the present disclosure provides the cleaning method according to the twelfth or thirteenth aspect, further including (c) after obtaining the information about the first target object and before accepting the information indicating that the first target object is to be set as a cleaning target object, causing the display to display a second display screen that allows selection of whether to set the first target object as a cleaning target object. In the method, in a state where the second display screen is displayed, information indicating that the first target object is to be set or is not to be set as a cleaning target object is accepted.

A fifteenth aspect of the present disclosure provides the cleaning method according to the twelfth or thirteenth aspect, further including: (d1) in a case of accepting selection of the first movement mode in a state where the first display screen is displayed, moving the main body in accordance with the first movement mode; and (d2) in a case of accepting selection of the second movement mode in a state where the first display screen is displayed, moving the main body in accordance with the second movement mode.

A sixteenth aspect of the present disclosure provides the cleaning method according to any one of the twelfth to fifteenth aspects, in which, in (a), the information about the first target object is obtained on the basis of a camera image obtained by a camera included in the main body.

A seventeenth aspect of the present disclosure provides the cleaning method according to any one of the twelfth to sixteenth aspects, in which in (a), the information about the first target object is obtained on the basis of information about objects detected by a first sensor included in the main body.

An eighteenth aspect of the present disclosure provides the cleaning method according to any one of the twelfth to seventeenth aspects, in which, in (a), the information about the first target object is obtained on the basis of information about the stuck state detected by a second sensor that detects the stuck state.

A nineteenth aspect of the present disclosure provides the cleaning method according to any one of the twelfth to seventeenth aspects, further including: (e1) controlling a driver to drive the main body on the basis of selection of the second movement mode, the driver being included in the main body and driving movement of the main body; and (e2) in a case of detecting the main body exiting the stuck state after detection of the stuck state by a second sensor, changing the second movement mode to the first movement mode and controlling the driver to drive the main body, the second sensor being included in the autonomous mobile cleaning apparatus and detecting the stuck state.

A twentieth aspect of the present disclosure provides the cleaning method according to any one of the twelfth to seventeenth aspects, further including: (e1) controlling a driver to drive the main body on the basis of selection of the second movement mode, the driver being included in the main body and driving movement of the main body; and (e2) in a case of detecting the main body exiting the stuck state after detection of the stuck state by a second sensor, causing the display to display the first display screen, the second sensor being included in the autonomous mobile cleaning apparatus and detecting the stuck state.

A twenty-first aspect of the present disclosure provides the cleaning method according to any one of the twelfth to seventeenth aspects, further including: (f1) accepting selection of the second movement mode in a state where the first display screen is displayed; (f2) selecting one operation control mode from among operation control modes as a first operation control mode and controlling a driver on the basis of the first operation control mode and the second movement mode to drive the main body, the driver being included in the main body and driving movement of the main body; and (f3) in a case of detecting the main body exiting the stuck state after detection of the stuck state by a second sensor, selecting an operation control mode different from the first operation control mode as a second operation control mode from among the operation control modes and controlling the driver in accordance with the second operation control mode and the second movement mode to drive the main body, the second sensor being included in the autonomous mobile cleaning apparatus and detecting the stuck state. In the method, the second operation control mode is different from the first operation control mode in a movement speed, a movement direction, or rotation or stop of a side brush of the main body.

A twenty-second aspect of the present disclosure provides the cleaning method according to the twenty-first aspect, further including (f4) in a case of detection of the stuck state by the second sensor after driving the main body in accordance with the second operation control mode and the second movement mode, changing the second movement mode to the first movement mode and controlling the driver to drive the main body.

A twenty-third aspect of the present disclosure provides a non-transitory computer-readable recording medium storing a program for causing a device including a processor to execute processing, the processing being a cleaning method for an autonomous mobile cleaning apparatus, the method including: (a) obtaining information about a first target object having a possibility of putting a main body included in the autonomous mobile cleaning apparatus into a stuck state, the main body including a suction unit; and (b) accepting information indicating that the first target object is to be set as a cleaning target object, and thereafter, causing a display included in the autonomous mobile cleaning apparatus to display a first display screen that allows selection of a first movement mode or a second movement mode. The autonomous mobile cleaning apparatus is caused to climb over the first target object in a first process, the autonomous mobile cleaning apparatus is caused to clean a first area except for the first target object in a second process, the second process is performed prior to the first process in the first movement mode, and the first process is performed prior to the second process in the second movement mode.

According to the twenty-third aspect, movement modes that take into consideration the order of cleaning of a target object having a possibility of creating a stuck state and cleaning of a portion other than the target object can be generated and provided to a user.

### Underlying Knowledge Forming Basis of the Present Disclosure

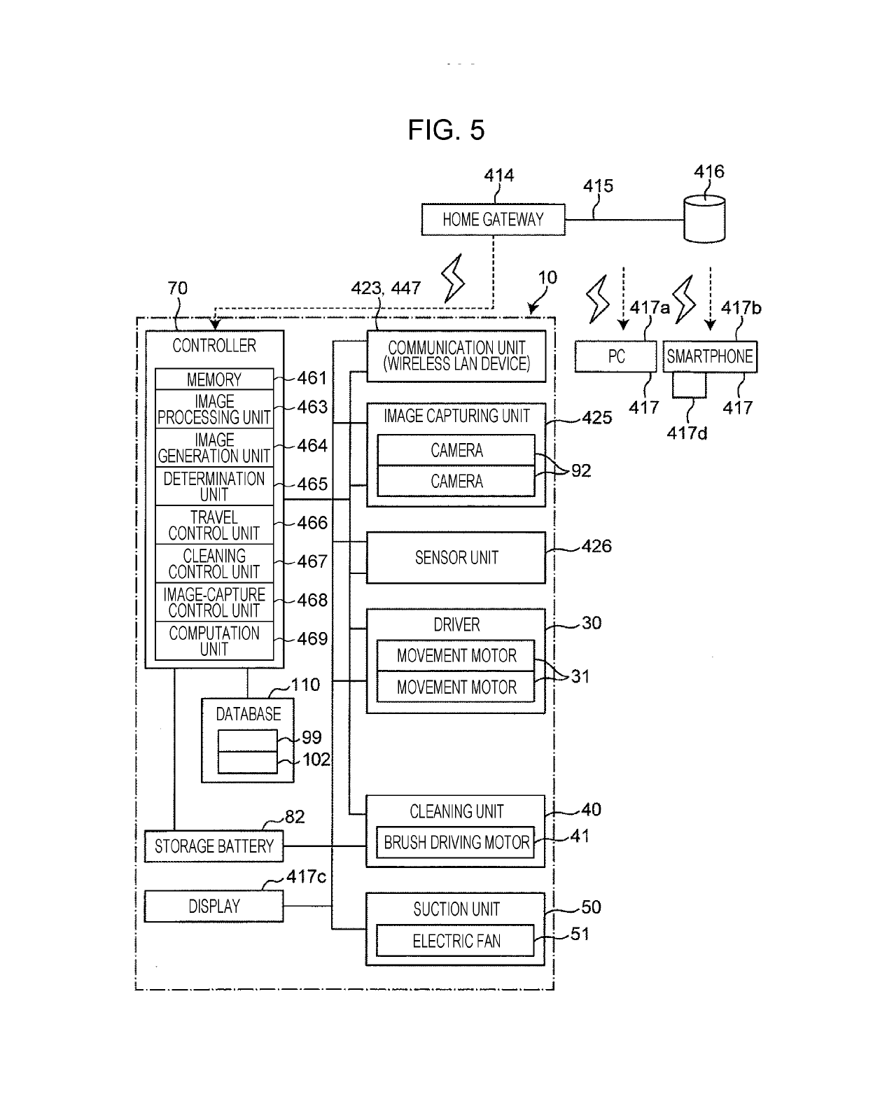

The movement path creation apparatus disclosed by Japanese Unexamined Patent Application Publication No. 2006-277121 obtains information about an area across which the mobile robot is unable to move and creates a movement path that does not include the area across which the mobile robot is unable to move. An area across which the mobile robot is unable to move is determined on the basis of information about whether or not the area includes a height level difference that the mobile robot is unable to climb over. Determination as to whether or not the area includes a height level difference that the mobile robot is unable to climb over is performed on the basis of a predetermined possible-height-level-difference attribute or a question asked to a user (see paragraphs [0040] and [0088] and FIG. 5 of Japanese Unexamined Patent Application Publication No. 2006-277121).

The present inventors think that, in a case where the mobile robot is an autonomous mobile cleaning apparatus, a movement path needs to be created not on the basis of whether the mobile robot is able to move across an area of interest but on the basis of whether the user wants to clean an area of interest.

In a case where an area that the user wants to clean is an area in which a cleaning apparatus has difficulty in moving, the cleaning apparatus has a possibility of failing to move in the area. Here, the state where “a cleaning apparatus fails to move” means that the cleaning apparatus becomes unable to move (is stuck). More specifically, this state means that the cleaning apparatus attempts to move onto an area in which the cleaning apparatus has difficulty in moving, and as a result, the cleaning apparatus catches on, for example, a target object located in the area and is stuck. Here, “target object” is an object that is located within an area that the user wants to clean, and the upper surface thereof is also an area that the user wants to clean. It is assumed that the cleaning apparatus usually climbs onto the target object, cleans the upper surface, and descends to the floor from the upper surface.

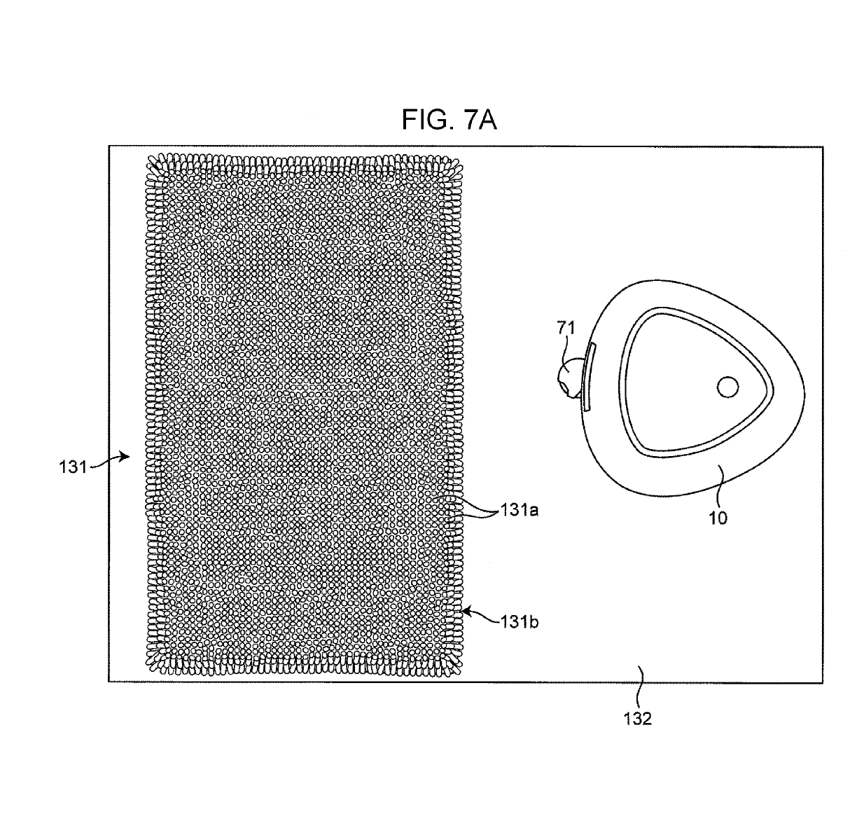

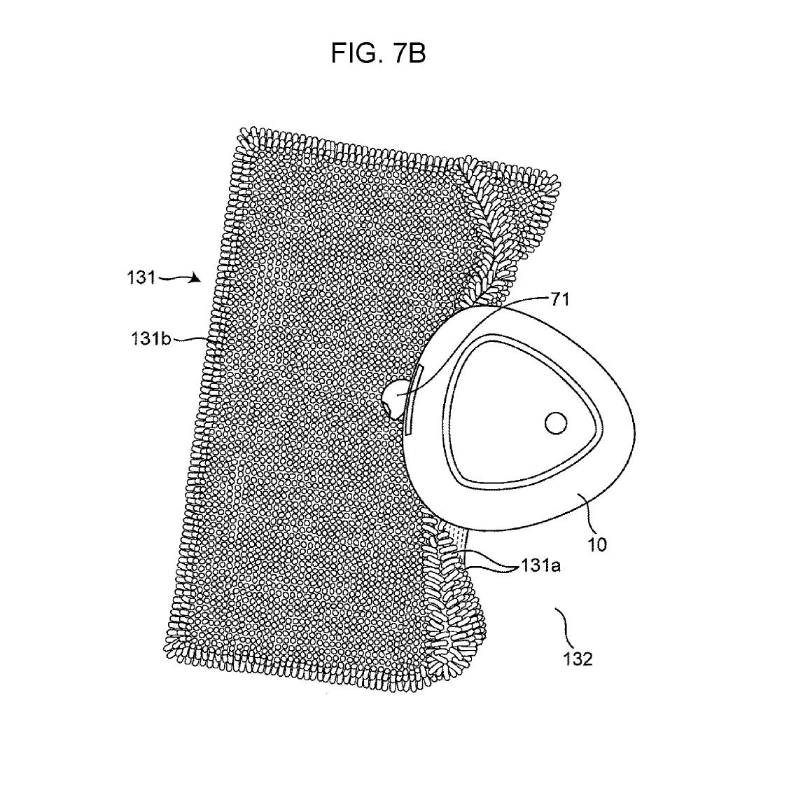

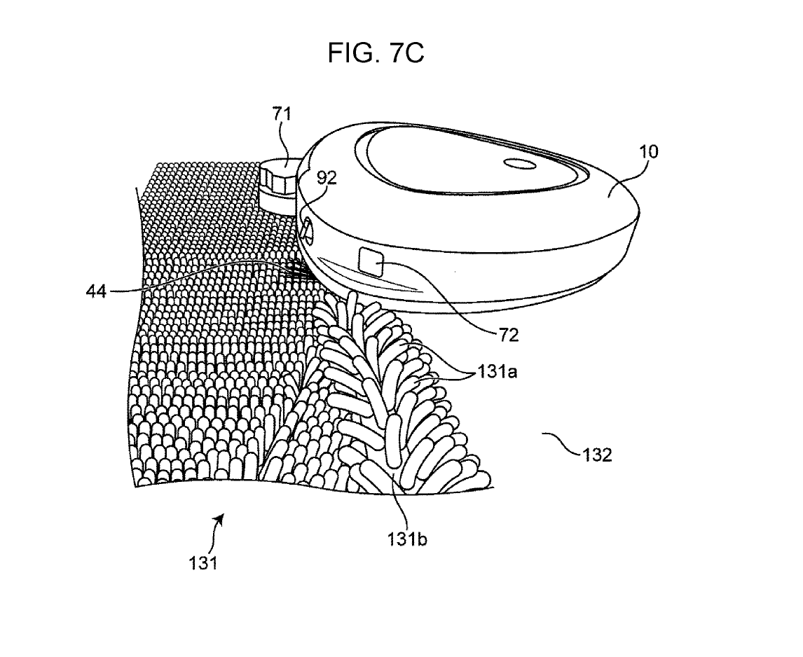

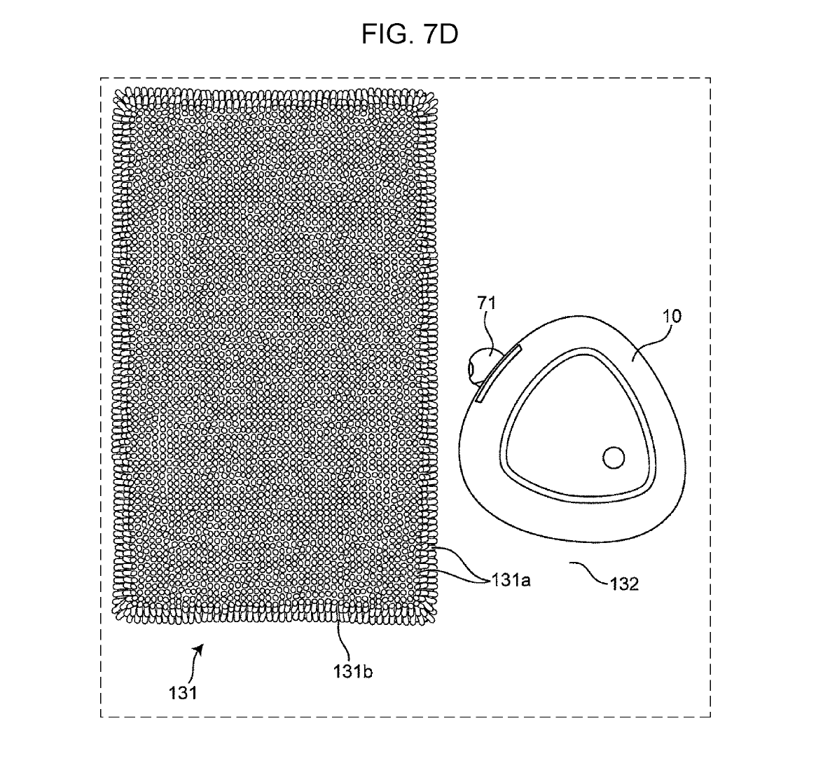

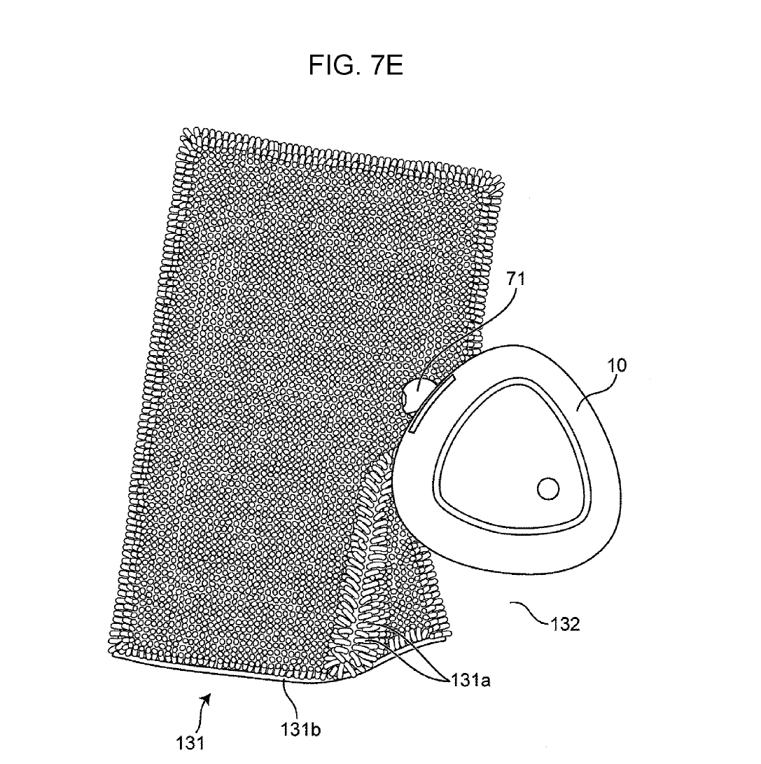

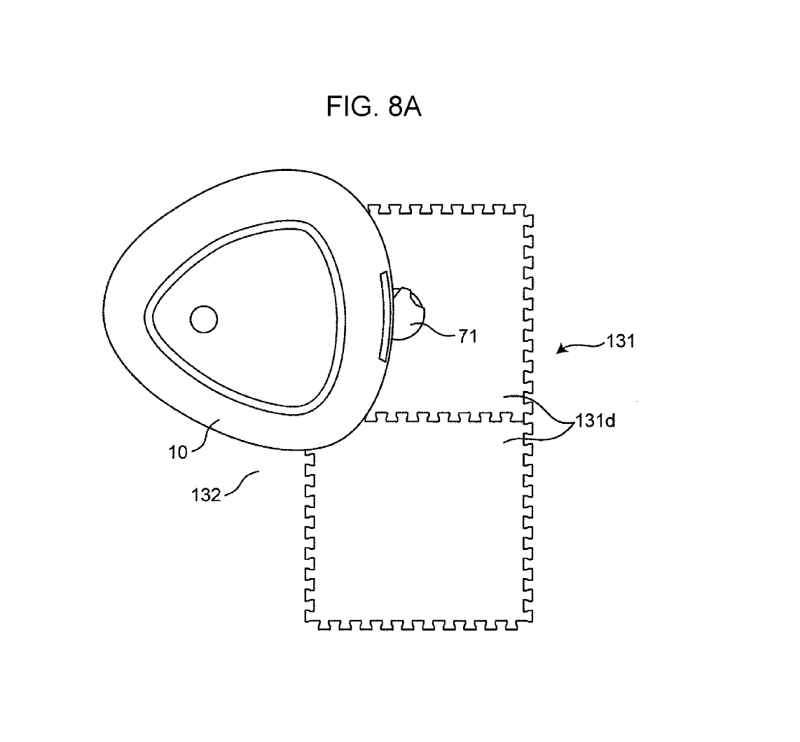

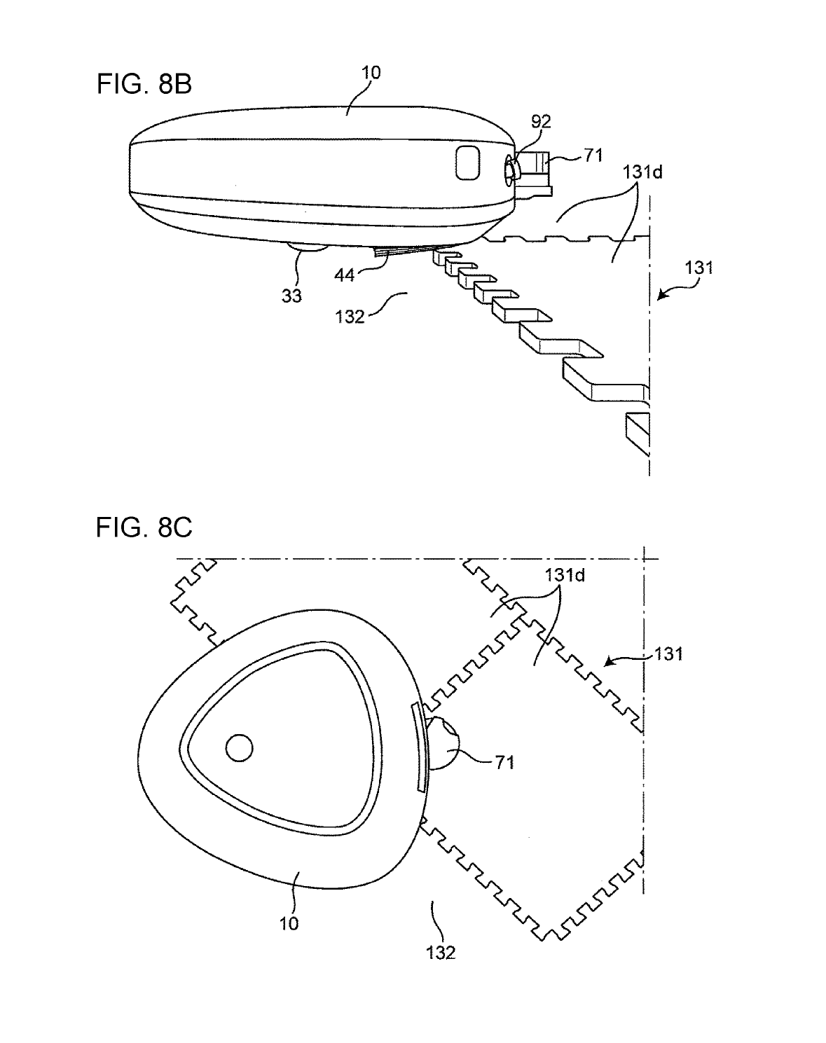

The stuck state is described below with reference to FIGS. 7A to 7C and FIGS. 8A and 8B.

Three examples of the stuck state are described below.

### Stuck State 1

FIG. 7A and FIG. 7B illustrate a cleaning apparatus 10 when viewed from above. It is assumed that, as an example of a target object 131, a rug 131b having long threads 131a is placed on a floor 132 so as to be relatively movable, as illustrated in FIG. 7A. When the cleaning apparatus 10 moves on the floor 132 and comes into contact with the target object 131, as illustrated in FIG. 7B, the target object 131 has a possibility of moving relative to the floor 132 together with the cleaning apparatus 10. FIG. 7C illustrates the cleaning apparatus 10 and the target object 131 in the state illustrated in FIG. 7B when viewed sideways. As illustrated in FIG. 7C, when the target object 131 catches under the cleaning apparatus 10, the altitude of the target object 131 becomes equal to or higher than a predetermined altitude (for example, 2 cm or more). At this time, in a case where the cleaning apparatus 10 further moves to the target object 131, the cleaning apparatus 10 is pushed upward by the target object 131 relative to the floor 132. As a result, for example, wheels 33 of the cleaning apparatus 10 may be unable to exert a driving force on the floor 132 or the wheels 33 of the cleaning apparatus 10 may come off the floor 132, and the cleaning apparatus 10 may be stuck.

### Stuck State 2

FIG. 8A and FIG. 8B illustrate the cleaning apparatus 10 when viewed from above and sideways. It is assumed that, as another example of the target object 131, interlocking foam mats 131d are placed on the floor 132 so as to be relatively movable, as illustrated in FIG. 8A. The target object 131 is soft, and therefore, when the wheels 33 of the cleaning apparatus 10 are about to climb onto an edge of the target object 131, as illustrated in FIG. 8B, the edge may be elastically deformed, the wheels 33 of the cleaning apparatus 10 may slip, and the cleaning apparatus 10 may be stuck.

### Stuck State 3

Another example case is assumed where, as the target object 131, the rug 131b having the long threads 131a is placed as in the example illustrated in FIG. 7A. Side brushes 44 of the cleaning apparatus 10 for sweeping dust in, for example, the corners of a room may catch in the threads 131a of the target object 131, and the cleaning apparatus 10 may be stuck.

In a case where the condition in at least one of stuck state 1 to stuck state 3 as described above is satisfied, the cleaning apparatus 10 enters the “stuck state”.

As described above, an area in which the cleaning apparatus has difficulty in moving is also referred to as “area with movement difficulties”.

In a case where the cleaning apparatus 10 attempts to move onto an area with movement difficulties, the user selects one movement method from among plural movement methods, the selection instruction is accepted, and the cleaning apparatus 10 attempts to move onto the area with the selected movement method. Such an operation is repeatedly performed, and as a result, the cleaning apparatus 10 can obtain a movement method with which the cleaning apparatus 10 successfully moves onto the area with movement difficulties.

In the stage where the cleaning apparatus 10 attempts to move onto an area with movement difficulties, there is a possibility that the cleaning apparatus 10 fails in moving and enters a stuck state. In this case, for example, the user or a robot can pick up the cleaning apparatus 10 off the area with movement difficulties to assist the cleaning apparatus 10 in exiting the stuck state, and thereafter, the cleaning apparatus 10 can attempt to move onto the area with movement difficulties with another movement method.

However, a situation where the user or a robot always needs to stay in proximity to the cleaning apparatus 10 in order to assist the cleaning apparatus 10 in exiting a stuck state is not practical from the viewpoint of convenience.

Therefore, the present inventors have conceived a cleaning apparatus that is able to set a movement path in accordance with the situation of the user or robot by allowing selection and acceptance of movement modes taking into consideration a point on a movement path of the cleaning apparatus at which the cleaning apparatus attempts to move to an area with movement difficulties.

### First Embodiment

Hereinafter, embodiments of the present disclosure will be described with reference to the drawings.

### Overall Configuration

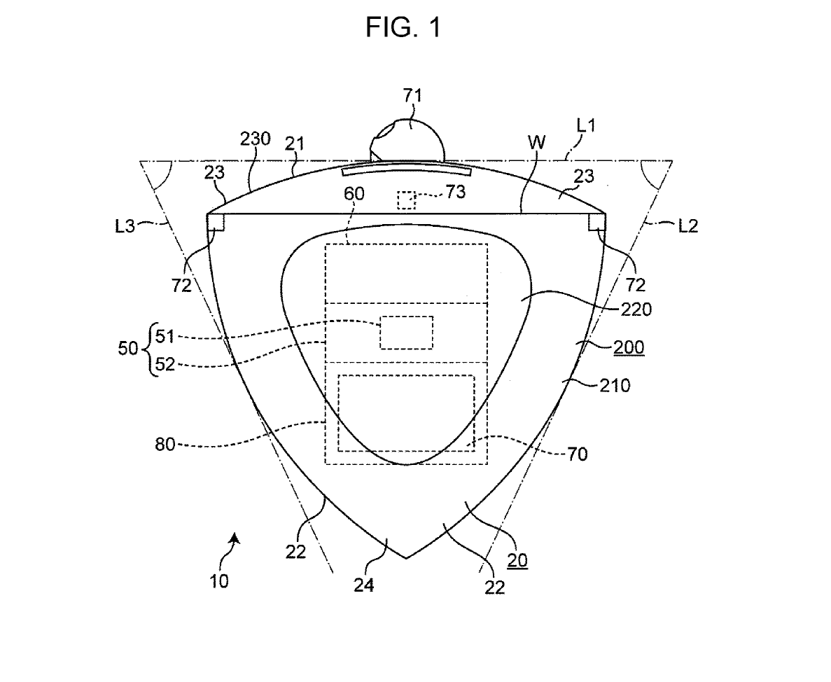

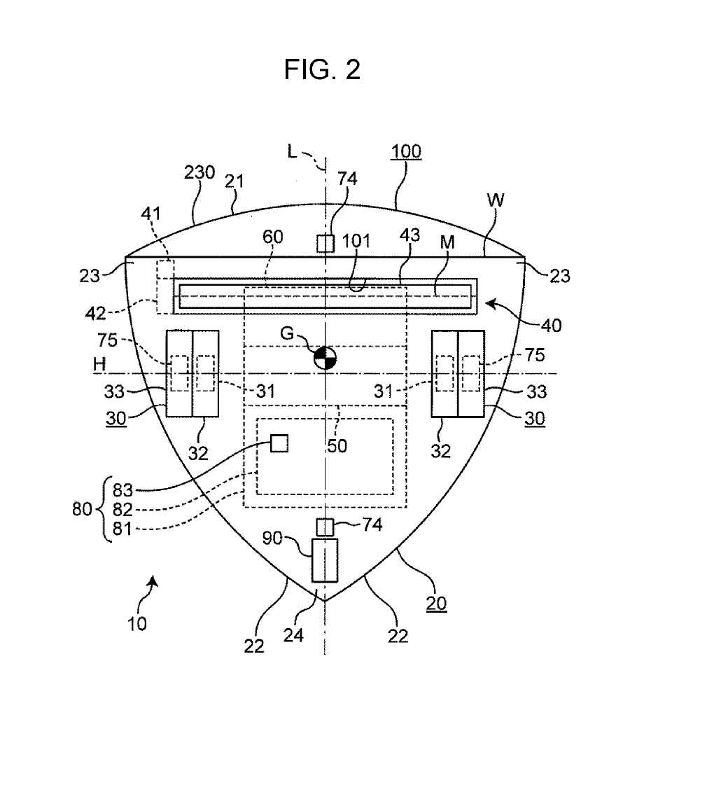

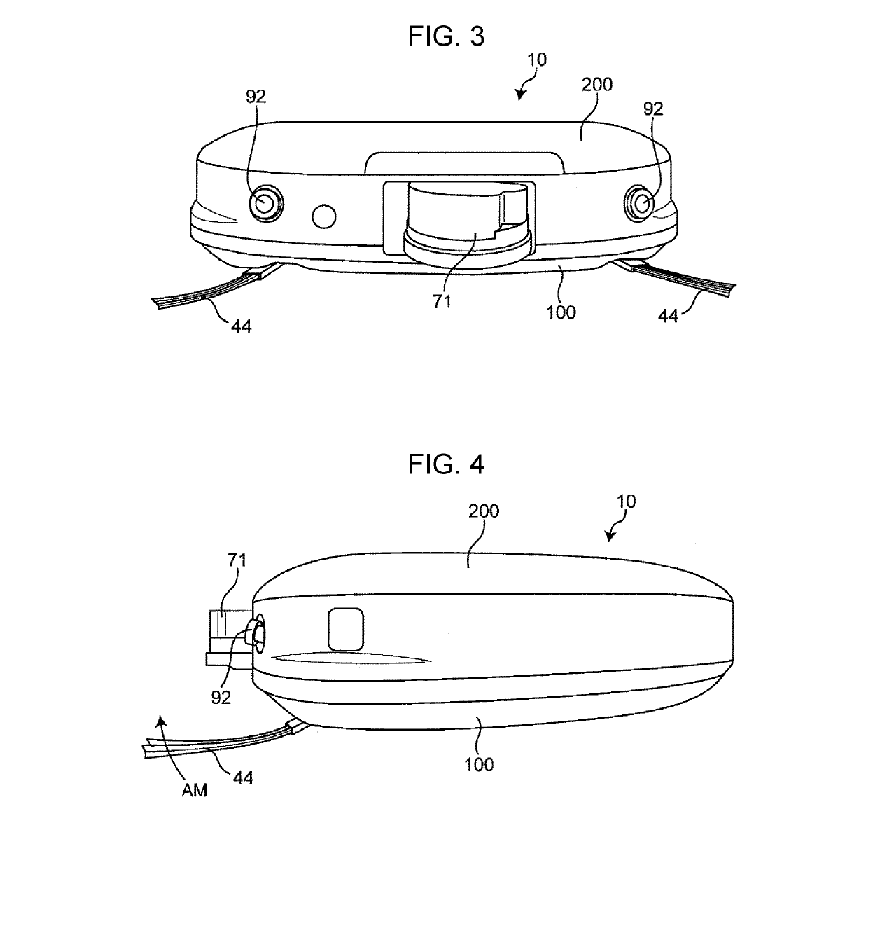

FIG. 1 is a plan view of the cleaning apparatus 10 according to a first embodiment. FIG. 2 is a bottom view of the cleaning apparatus 10. FIG. 3 is a front view of the cleaning apparatus 10. FIG. 4 is a side view of the cleaning apparatus 10.

The cleaning apparatus 10 illustrated in FIG. 1 autonomously moves on a surface to be cleaned, that is, a cleaning surface, of an area to be cleaned (hereinafter sometimes referred to as “cleaning area” or simply referred to as “target area”). In other words, the cleaning apparatus 10 is a robot-type autonomous mobile cleaning apparatus that sucks up dust present on a cleaning surface. A target area to be cleaned is, for example, a room, and a cleaning surface is, for example, the surface of the floor or the surface of the walls of the room.

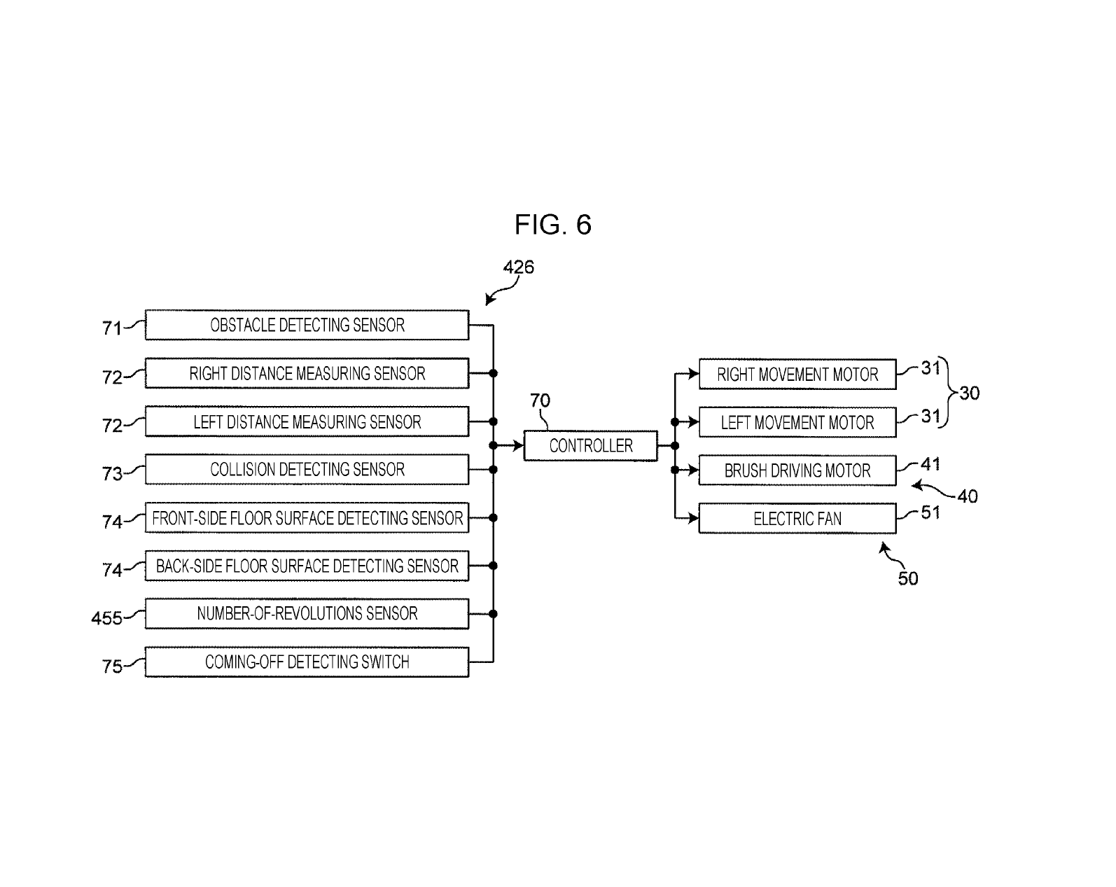

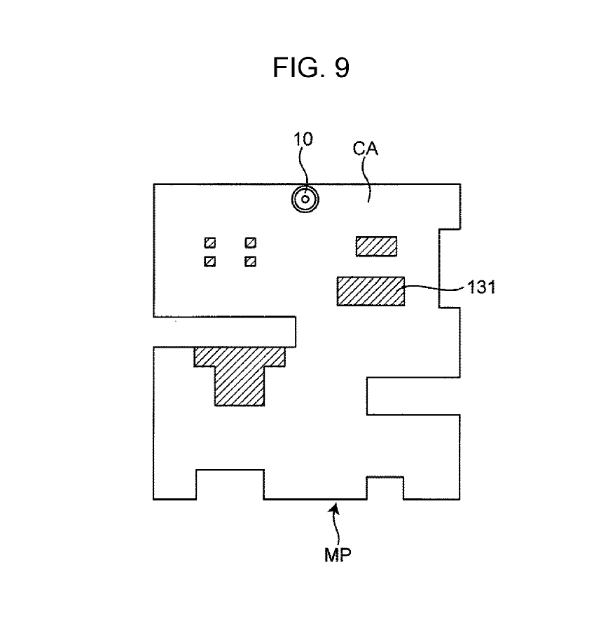

FIG. 5 is a functional block diagram of the cleaning apparatus 10. FIG. 6 is a functional block diagram illustrating, in more detail, some of the constituent elements of the cleaning apparatus 10 illustrated in FIG. 5. The cleaning apparatus 10 illustrated in FIG. 1 to FIG. 5 includes at least a cleaning apparatus main body 20, drivers 30, and a suction unit 50. The cleaning apparatus 10 further includes a cleaning unit 40. The drivers 30, the cleaning unit 40, and the suction unit 50 are mounted in the cleaning apparatus main body 20. The drivers 30 drive movement of the cleaning apparatus main body 20. The cleaning unit 40 collects dust present in a cleaning area CA (see FIG. 9). The suction unit 50 sucks collected dust into the cleaning apparatus main body 20.

The cleaning apparatus 10 further includes a dust box 60 and a controller 70 in the cleaning apparatus main body 20. The dust box 60 stores dust sucked by the suction unit 50. The controller 70 controls at least the drivers 30 and the suction unit 50. The controller 70 can control the cleaning unit 40.

The cleaning apparatus 10 further includes the wheels 33 and a power supply unit 80. The wheels 33 rotate by following rotational driving by the drivers 30. The power supply unit 80 supplies power to the drivers 30, the cleaning unit 40, the suction unit 50, and so on.

In FIG. 1 and FIG. 2, the upper side is defined as the front direction of the cleaning apparatus main body 20, and the lower side is defined as the back direction of the cleaning apparatus main body 20. The width direction of the cleaning apparatus 10 is defined on the basis of the front direction of the cleaning apparatus 10 (for example, the upper side in FIG. 1). In the first embodiment, for example, a direction substantially orthogonal to the front direction of the cleaning apparatus 10 (for example, the right-left direction in FIG. 1 and FIG. 2) is defined as the width direction of the cleaning apparatus 10. The front direction is also referred to as a forward direction, and the back direction is also referred to as a backward direction.

The drivers 30 are provided in a pair in the first embodiment. One driver 30 is disposed to the right and to the left of the center in the width direction of the cleaning apparatus main body 20 in plan view. Hereinafter, the left driver 30 is sometimes referred to as a first driver, and the right driver 30 is sometimes referred to as a second driver. Note that the number of the drivers 30 is not limited to two and may be one or three or more. The details of the drivers 30 will be described below.

### Cleaning Apparatus Main Body 20

The cleaning apparatus main body 20 includes a lower casing 100 (see FIG. 2) that defines the external form of the lower surface side of the cleaning apparatus main body 20 and an upper casing 200 (see FIG. 1) that defines the external form of the upper surface side of the cleaning apparatus main body 20. The lower casing 100 and the upper casing 200 are combined with each other to form the cleaning apparatus main body 20. As illustrated in FIG. 1, the upper casing 200 includes a cover 210 that constitutes a large part of the upper casing 200, a lid 220 that is provided so as to be openable and closable relative to the cover 210, and a bumper 230 that is displaceable relative to the cover 210.

Preferably, the planar shape of the cleaning apparatus main body 20 is a Reuleaux triangle, a Reuleaux polygon having a shape substantially the same as the shape of a Reuleaux triangle, or a Reuleaux triangle or a Reuleaux polygon having round vertexes. Such a shape can be used to bring features the same as or similar to the geometric features of a Reuleaux triangle to the cleaning apparatus main body 20. That is, a Reuleaux triangle is a shape of constant width, and therefore, can rotate within a rectangle having a constant width (that is, the length of the sides of an equilateral triangle inscribed in the Reuleaux triangle) in any direction while touching the rectangle. Accordingly, the cleaning apparatus main body 20 can draw a rectangular locus (that is, a substantially square locus). In the first embodiment, the cleaning apparatus main body 20 has a planar shape substantially the same as the shape of a Reuleaux triangle, as illustrated in FIG. 1. Other examples of the planar shape of the cleaning apparatus main body 20 include a circle and an ellipse.

The cleaning apparatus main body 20 includes perimeter surfaces and vertex portions. In the first embodiment, the perimeter surfaces include a front surface 21 that is present on the forward side of the cleaning apparatus 10 (for example, the upper side in FIG. 1), a right side surface 22 that is present on the right back side relative to the front surface 21, and a left side surface 22 that is present on the left back side relative to the front surface 21. In the first embodiment, the front surface 21 has a curved surface that is curved so as to project outward. The bumper 230 may have the curved surface that is curved so as to project outward. Each side surface 22 at least partially has a curved surface that is curved so as to project outward. In the first embodiment, the curved surface that is curved so as to project outward is formed on the side portion of the bumper 230 and the side portions of the cover 210.

In the first embodiment, the vertex portions include a right front vertex portion 23 that is defined by the front surface 21 and the right side surface 22, and a left front vertex portion 23 that is defined by the front surface 21 and the left side surface 22. The vertex portions may further include a back vertex portion 24 that is defined by the right side surface 22 and the left side surface 22. As illustrated in FIG. 1, both the angle made by the tangent L1 to the front surface 21 and the tangent L2 to one of the two side surfaces 22 and the angle made by the tangent L1 to the front surface 21 and the tangent L3 to the other side surface 22 are acute angles.

The maximum width of the cleaning apparatus main body 20 is defined by the distance between the vertexes of the vertex portions of the cleaning apparatus main body 20. In the first embodiment, the maximum width of the cleaning apparatus main body 20 is defined by the right front vertex portion 23 and the left front vertex portion 23. In the example illustrated in, for example, FIG. 1, the maximum width of the cleaning apparatus main body 20 is defined by the distance between the vertex of the right front vertex portion 23 and the vertex of the left front vertex portion 23, that is, the distance between two vertexes among the three vertexes of the Reuleaux triangle.

In the cleaning apparatus main body 20, a line segment W (hereinafter referred to as “maximum-width line segment W of the cleaning apparatus main body 20”) that connects the vertex of the right front vertex portion 23 with the vertex of the left front vertex portion 23 and the vicinity of the line segment W are referred to as “portion having the maximum width of the cleaning apparatus main body 20” or “maximum-width portion of the cleaning apparatus main body 20”. The terms “vicinity of the maximum-width line segment W of the cleaning apparatus main body 20” and “portion close to the maximum-width line segment W of the cleaning apparatus main body 20” indicate a portion close to the maximum-width line segment W of the cleaning apparatus main body 20, that is, a portion between the maximum-width line segment W of the cleaning apparatus main body 20 and the center of gravity G (see FIG. 2) of the cleaning apparatus 10 and a portion between the maximum-width line segment W of the cleaning apparatus main body 20 and the front surface 21. More specifically, the terms indicate a portion between the maximum-width line segment W of the cleaning apparatus main body 20 and the front edges of the drivers 30 in the forward direction of the cleaning apparatus main body 20 and the portion between the maximum-width line segment W of the cleaning apparatus main body 20 and the front surface 21.

Preferably, the maximum-width portion of the cleaning apparatus main body 20 is positioned close to the front surface 21 of the cleaning apparatus main body 20. Preferably, the direction in which the maximum-width line segment W of the cleaning apparatus main body 20 extends is set so as to be substantially orthogonal to the forward direction of the cleaning apparatus main body 20.

As illustrated in FIG. 2, the cleaning apparatus main body 20 further includes a suction inlet 101 for sucking dust into the cleaning apparatus main body 20. The suction inlet 101 is formed on the bottom surface of the lower casing 100 of the cleaning apparatus main body 20. The suction inlet 101 has a long narrow shape, and preferably, has a rectangular shape or a substantially rectangular shape. The shape of the suction inlet 101 is not limited to these shapes and may be an elliptic shape, a trapezoidal shape, or a shape that curves along the perimeter shape of the cleaning apparatus main body 20. In the first embodiment, the suction inlet 101 has a rectangular shape. Further, in the first embodiment, the suction inlet 101 is disposed on the bottom surface of the lower casing 100 of the cleaning apparatus main body 20 such that the long-side direction thereof is substantially the same as the width direction of the cleaning apparatus main body 20 and the short-side direction thereof is substantially the same as the front-back direction of the cleaning apparatus main body 20.

The suction inlet 101 is formed in a portion close to the portion having the maximum width of the cleaning apparatus main body 20, and more preferably, in the portion close to the maximum-width line segment W of the cleaning apparatus main body 20 on the bottom surface of the lower casing 100 of the cleaning apparatus main body 20. This positional relationship is more specifically defined by the positional relationship between the suction inlet 101 and other constituent elements and so on of the cleaning apparatus 10 and, for example, is defined by one of or both the following two types of positional relationships.

The first positional relationship is such that the suction inlet 101 is located closer to the front side of the cleaning apparatus main body 20 than the center of gravity G (see FIG. 2) of the cleaning apparatus 10. More specifically, the center line M of the suction inlet 101 (hereinafter referred to as “center line of the suction inlet 101 in the long-side direction”) that extends in a direction substantially the same as the long-side direction of the suction inlet 101 is located closer to the front side of the cleaning apparatus main body 20 than the center of gravity G (see FIG. 2) of the cleaning apparatus 10, that is, located in the front portion of the cleaning apparatus main body 20, that is, in the maximum-width portion of the cleaning apparatus main body 20. The center line of the suction inlet 101 in the long-side direction may be located in a portion close to the front surface 21 than the maximum-width line segment W of the cleaning apparatus main body 20.

The second positional relationship is such that the suction inlet 101 is located in a portion closer to the maximum-width line segment W of the cleaning apparatus main body 20 than the drivers 30, preferably, on the maximum-width line segment W of the cleaning apparatus main body 20 or in the vicinity of the maximum-width line segment W, and more preferably, in a portion closer to the front surface 21 than the maximum-width line segment W of the cleaning apparatus main body 20.

In the first embodiment, the width of the suction inlet 101 in the long-side direction is made wider than the distance between the inner side of the right driver 30 and the inner side of the left driver 30. Such a configuration can be implemented by, for example, employing the second positional relationship of the suction inlet 101 described above. With such a configuration, the suction inlet 101 having a larger width can be provided, dust can be directly sucked through the suction inlet 101 with more certainty, and the amount of dust sucked into the suction unit 50 described below can be increased.

### Drivers 30

The drivers 30 are located in the cleaning apparatus main body 20.

As illustrated in FIG. 2, the drivers 30 are disposed on the bottom surface side of the lower casing 100 and each have elements, such as the wheel 33 that moves on a floor. In the first embodiment, each driver 30 includes a movement motor 31 that applies a torque to the wheel 33 and a housing 32 that accommodates the movement motor 31 in addition to the wheel 33, which moves on a floor. Each wheel 33 is accommodated in a recess formed in the lower casing 100 and supported by the lower casing 100 so as to be rotatable relative to the lower casing 100.

Each wheel 33 is disposed closer to the outer side of the cleaning apparatus main body 20 in the width direction than the movement motor 31 that applies a torque to the wheel 33. With such a configuration, the gap between the right wheel 33 and the left wheel 33 becomes wider than that in a case where each wheel 33 is disposed closer to the inner side in the width direction than the movement motor 31, which contributes to more stable movement of the cleaning apparatus main body 20.

The driving system of the cleaning apparatus 10 of the first embodiment is a system of parallel two-wheel type. That is, the right driver 30 and the left driver 30 are disposed so as to face each other in the width direction of the cleaning apparatus main body 20. In the first embodiment, as illustrated in FIG. 2, the rotation axis H of the right wheel 33 and the rotation axis H of the left wheel 33 are positioned so as to be present on substantially the same axis.

The distance between the rotation axis H and the center of gravity G of the cleaning apparatus 10 is set so as to bring, for example, a predetermined turning ability to the cleaning apparatus 10. The predetermined turning ability is a turning ability that enables the cleaning apparatus main body 20 to draw a locus the same as or similar to a rectangular locus drawn by the outline of a Reuleaux triangle described above. In the first embodiment, the rotation axis H is positioned closer to the back side of the cleaning apparatus main body 20 than the center of gravity G, and the rotation axis H and the center of gravity G are positioned at a predetermined distance. When the cleaning apparatus 10 of parallel two-wheel type employs such a configuration, the cleaning apparatus 10 can draw the locus as described above as the cleaning apparatus main body 20 comes into contact with objects around the cleaning apparatus main body 20.

### Cleaning Unit 40

As illustrated in FIG. 2, the cleaning unit 40 is disposed inside and outside the cleaning apparatus main body 20 and includes elements, such as a brush driving motor 41. In the first embodiment, the cleaning unit 40 includes a gearbox 42 and a main brush 43 disposed in the suction inlet 101 of the cleaning apparatus main body 20 in addition to the brush driving motor 41, which is disposed inside the cleaning apparatus main body 20 (for example, on the left side of the suction inlet 101).

The brush driving motor 41 and the gearbox 42 are fixed to the lower casing 100. The gearbox 42 is connected to the output shaft of the brush driving motor 41 and to the main brush 43 and transmits a torque of the brush driving motor 41 to the main brush 43.

The main brush 43 has a length substantially the same as the length of the suction inlet 101 in the long-side direction and is supported by a bearing so as to be rotatable relative to the lower casing 100. The bearing is formed in, for example, one of or both the gearbox 42 and the lower casing 100. In the first embodiment, the rotation direction of the main brush 43 is set to a direction in which the rotation path extends from the front to the back of the cleaning apparatus main body 20 on the floor side, as indicated by the arrow AM in FIG. 4, which is a side view of the cleaning apparatus 10.

### Suction Unit 50

As illustrated in FIG. 1, the suction unit 50 is disposed inside the cleaning apparatus main body 20 and includes elements, such as a fan case 52. In the first embodiment, the suction unit 50 is disposed on the back side of the dust box 60 and on the front side of the power supply unit 80. The suction unit 50 includes the fan case 52, which is fixed to the lower casing 100 (see FIG. 2), and an electric fan 51 disposed inside the fan case 52.

The electric fan 51 is used to suck air inside the dust box 60 and discharge the air to the outside of the electric fan 51. The air discharged by the electric fan 51 passes through the space inside the fan case 52 and a space around the fan case 52 within the cleaning apparatus main body 20 and is exhausted to the outside of the cleaning apparatus main body 20.

### Dust Box 60

As illustrated in FIG. 2, the dust box 60 is disposed behind the main brush 43 and on the front side of the suction unit 50 in the cleaning apparatus main body 20 and is disposed between the drivers 30. The cleaning apparatus main body 20 and the dust box 60 have an attachable/detachable structure that allows a user to select a state where the dust box 60 is attached to the cleaning apparatus main body 20 and a state where the dust box 60 is detached from the cleaning apparatus main body 20 as desired.

### Sensor Unit 426

As illustrated in FIG. 1, FIG. 2, FIG. 5, and FIG. 6, the cleaning apparatus 10 further includes a sensor unit 426 constituted by sensors.

The sensor unit 426 includes an obstacle detecting sensor 71, distance measuring sensors 72, a collision detecting sensor 73, and floor surface detecting sensors 74.

The obstacle detecting sensor 71 detects an obstacle present in front of the cleaning apparatus main body 20 (see FIG. 1). The obstacle detecting sensor 71 is an example of a first sensor. For example, the obstacle detecting sensor 71 is disposed on the front surface of the cleaning apparatus main body 20 so as to project and is able to detect the presence and form of an object and the distance to the object. The obstacle detecting sensor 71 need not be disposed at the center of the front surface and may be disposed in the upper portion of the cleaning apparatus main body 20 so as to project. For example, the obstacle detecting sensor 71 may project from the cleaning apparatus main body 20 such that a laser beam emitted therefrom is not blocked by the cleaning apparatus main body 20.

The distance measuring sensors 72 each detect the distance between an object present around the cleaning apparatus main body 20 and the cleaning apparatus main body 20 (see FIG. 1).

The collision detecting sensor 73 detects a collision of the cleaning apparatus main body 20 with an object around the cleaning apparatus main body 20 (see FIG. 1).

The floor surface detecting sensors 74 each detect a floor surface on which the cleaning apparatus main body 20 is located (see FIG. 2).

The obstacle detecting sensor 71, the distance measuring sensors 72, the collision detecting sensor 73, and the floor surface detecting sensors 74 each input a detection signal to the controller 70.

As the obstacle detecting sensor 71, for example, a laser distance-measuring device (laser range finder) that emits a laser beam in a range of 180 degrees at predetermined intervals of, for example, 1 second and measures a distance is used. The obstacle detecting sensor 71 can detect an object, such as a table or a chair, and also can detect whether the target object 131, such as a rug or a mat, is present on the floor on the basis of the distance between the object or the target object 131 and the cleaning apparatus main body 20. In a case where the target object 131 is present, the obstacle detecting sensor 71 can detect the form of the object or the target object 131 and the distance to the object or the target object 131.

As the distance measuring sensors 72 and the floor surface detecting sensors 74, for example, infrared sensors or laser distance-measuring devices (laser range finders) are used. The distance measuring sensors 72 and the floor surface detecting sensors 74 each include a light emitting unit and a light receiving unit. As the collision detecting sensor 73, for example, a contact-type displacement sensor is used. The collision detecting sensor 73 includes, for example, a switch that is disposed in the cleaning apparatus main body 20 and is turned on in response to the bumper 230 being pressed against the cover 210.

As illustrated in FIG. 1, in the first embodiment, the distance measuring sensors 72 are disposed on the right and left sides relative to the center in the width direction of the cleaning apparatus main body 20 in plan view. The right distance measuring sensor 72 is disposed in the right front vertex portion 23 and emits light in a diagonally forward right direction of the cleaning apparatus main body 20. The left distance measuring sensor 72 is disposed in the left front vertex portion 23 and emits light in a diagonally forward left direction of the cleaning apparatus main body 20. With such a configuration, when the cleaning apparatus 10 makes a turn, the distance between the cleaning apparatus main body 20 and an object, around the cleaning apparatus main body 20, that is closest to the periphery of the cleaning apparatus main body 20 can be detected.

As illustrated in FIG. 2, for example, one of the floor surface detecting sensors 74 is disposed closer to the front side of the cleaning apparatus main body 20 than the drivers 30, and the other is disposed closer to the back side thereof than the drivers 30. The floor surface detecting sensors 74 detect the distances from the floor surface on the front side and the back side of the cleaning apparatus main body 20. When the cleaning apparatus main body 20 is separated from the floor surface by a distance that exceeds a threshold, the floor surface detecting sensors 74 output an error signal so as to prevent the cleaning apparatus main body 20 from falling from the floor surface in, for example, a staircase.

The sensor unit 426 further includes, for example, a number-of-revolutions sensor 455, which is, for example, an optical encoder, that detects the number of revolutions of each wheel 33 (in other words, each movement motor 31). The number-of-revolutions sensor 455 detects and inputs, to the controller 70, the turning angle, the movement distance, or the amount of movement of the cleaning apparatus 10 (that is, the cleaning apparatus main body 20) on the basis of the measured number of revolutions of each wheel 33 (in other words, each movement motor 31). Accordingly, the number-of-revolutions sensor 455 is a position detecting sensor that detects the relative position of the cleaning apparatus 10 (that is, the cleaning apparatus main body 20) relative to a reference position that is the position of, for example, a charging device for a storage battery 82.

On the basis of the position of the cleaning apparatus 10 detected by the number-of-revolutions sensor 455, the cleaning area CA and positional relationships of objects and so on located within the cleaning area CA are calculated to generate a map MP (see FIG. 9).

The relative position can be used as the “present position” of the cleaning apparatus 10 described below.

On the respective sides of the obstacle detecting sensor 71 on the front surface of the cleaning apparatus main body 20, paired cameras 92 are disposed to obtain camera images including information about the surroundings of the cleaning apparatus main body 20. The details of the paired cameras 92 will be described below.

### Controller 70

In the example illustrated in FIG. 1, the controller 70 is disposed inside the cleaning apparatus main body 20 on the back side of the suction unit 50. Specifically, the controller 70 can be constituted by a control circuit.

For example, specifically, the hardware of the controller 70 is a microcontroller that includes a central processing unit (CPU), a read-only memory (ROM) that is a storage unit storing predetermined data, such as a program read by the CPU, and a random access memory (RAM) that is an area storage unit in which various memory areas, such as a work area used in data processing by the program, are dynamically formed. As illustrated in FIG. 5, the controller 70 further includes, for example, a memory 461, an image processing unit 463, an image generation unit 464, and a determination unit 465.

The memory 461 functions as a recording unit for recording, for example, data of images captured by the paired cameras 92, the presence and forms of objects and the distances to the objects obtained by the obstacle detecting sensor 71, the initial position of the cleaning apparatus main body 20, and the amount of movement from the initial position or the present position. To the memory 461, patterns (for example, images) for matching and object information that includes the presence and forms of objects and name information thereof used by the image processing unit 463 can be recorded.

The image processing unit 463 functions as a map generation unit that generates the map MP of the cleaning area CA on the basis of data of images captured by the paired cameras 92 and the presence and forms of objects and the distances to the objects obtained by the obstacle detecting sensor 71.

The image generation unit 464 functions as an image generation unit that generates a distance image on the basis of data of images captured by the paired cameras 92 and the presence and forms of objects and the distances to the objects obtained by the obstacle detecting sensor 71.

The determination unit 465 functions as an obstacle determination unit that determines whether objects are obstacles on the basis of data of images captured by the paired cameras 92 and the presence and forms of the objects and the distances to the objects obtained by the obstacle detecting sensor 71.

The controller 70 further includes, for example, a travel control unit 466, a cleaning control unit 467, an image-capture control unit 468, and a computation unit 469.

The travel control unit 466 controls the operations of the right and left movement motors 31 (that is, the paired wheels 33) in the drivers 30.

The cleaning control unit 467 controls the operations of the brush driving motor 41 in the cleaning unit 40 and the operations of the electric fan 51 in the suction unit 50.

The image-capture control unit 468 controls the paired cameras 92, which are included in an image capturing unit 425.

The computation unit 469 performs computation on the basis of the numbers of revolutions detected by the number-of-revolutions sensor 455 and obtains information about the amount of movement made by the drivers 30 of the cleaning apparatus main body 20 as positional information about the cleaning apparatus main body 20.

The controller 70 has, for example, a movement mode for driving the paired wheels 33 (that is, the paired movement motors 31) to autonomously move the cleaning apparatus 10 (that is, the cleaning apparatus main body 20), a charge mode for charging the storage battery 82 described below via a charging device, and a standby mode for suspending operations. These modes are recorded to the memory 461.

The movement mode includes at least:

(i) a first movement mode in which the cleaning apparatus 10 cleans the cleaning area CA except for a target object, and thereafter, climbs over the target object; and
(ii) a second movement mode in which the cleaning apparatus 10 first climbs over a target object, and thereafter, cleans the cleaning area CA except for the target object,
where, the cleaning area CA includes an area in which the target object is present.

Here, climbing over indicates an operation in which, for example, the cleaning apparatus 10 climbs onto a target object, cleans the upper surface of the target object, and thereafter, descends from the target object. The position at which the cleaning apparatus 10 climbs a target object and the position at which the cleaning apparatus 10 descends from the target object may be different or may be the same. After the cleaning apparatus 10 has climbed onto a target object, the cleaning apparatus 10 may clean the upper surface of the target object while moving in various directions. Alternatively, after the cleaning apparatus 10 has climbed onto a target object, the cleaning apparatus 10 may clean the upper surface of the target object while moving straight without turning, and thereafter, may descend from the target object.

When the image processing unit 463 functions as a map generation unit that generates the map MP of the cleaning area CA, various specific methods for map generation processing are available. For example, as a generation method to be used in a case where the cleaning apparatus 10 generates the map MP and as a method for estimating the own position of the cleaning apparatus 10, a technique called Simultaneous Localization and Mapping (SLAM) can be used. SLAM is a technique for estimating the own position of the cleaning apparatus 10 and creating an environment map simultaneously on the basis of information about the distances to objects detected by the sensor unit 426.

The idea of SLAM is briefly described below.

(1) The position of the observation point on a map is estimated on the basis of the position of the cleaning apparatus 10.

(2) The position of the cleaning apparatus 10 is consecutively estimated by using a technique of, for example, odometry in which the amount of movement is obtained from the number of revolutions of each wheel 33 of the cleaning apparatus 10.

(3) The point registered on the map MP is observed again, and the position of the cleaning apparatus 10 is corrected.

The image processing unit 463 creates simultaneous equations by combining equations used in (1) to (3) described above. When the image processing unit 463 solves the simultaneous equations by using the least square method, the position of the cleaning apparatus 10 and the map MP can be estimated, and a cumulative error can be reduced.

For details, see “Mobile Robot Perception: Mapping and Localization”, written by Masahiro Tomono, “Systems, Control and Information” vol. 60, No. 12, pp. 509 to 514, 2016 issued by The Institute of Systems, Control and Information Engineers.

The generated map MP is recorded to a map database 99 in a database 110 described below, and the estimated own position of the cleaning apparatus 10 is recorded to the memory 461 together with the time of estimation.

The memory 461 retains various types of data recorded thereto regardless of the power on/off of the cleaning apparatus 10. The memory 461 is, for example, a nonvolatile memory, such as a flash memory.

The image processing unit 463 calculates the distances between the cleaning apparatus 10 (that is, the cleaning apparatus main body 20) and objects around the cleaning apparatus 10 (that is, the cleaning apparatus main body 20) by using data of images captured by the paired cameras 92 and the presence and forms of the objects and the distances to the objects obtained by the obstacle detecting sensor 71. The image processing unit 463 uses the calculated distances and the position of the cleaning apparatus 10 (that is, the cleaning apparatus main body 20) detected by the number-of-revolutions sensor 455 of the sensor unit 426 to calculate the cleaning area CA in which the cleaning apparatus 10 (that is, the cleaning apparatus main body 20) is placed and positional relationships of the objects and so on located within the cleaning area CA, thereby generating the map MP (see FIG. 9).

The image generation unit 464 generates data of images captured by the paired cameras 92 and a distance image indicating the presence and forms of objects and the distances to the objects obtained by the obstacle detecting sensor 71.

The image generation unit 464 generates the distance image in such a manner that the image generation unit 464 converts data of images captured by the paired cameras 92 and the forms of objects and the distances to the objects obtained by the obstacle detecting sensor 71 to a gray scale that is represented by the luminance or the hue and that can be visually identifiable a predetermined number of dots by a predetermined number of dots, for example, for each dot of the images and displays the resulting image. In the first embodiment, the image generation unit 464 generates the distance image as a monochrome image in which the luminance decreases as the distance increases, that is, a gray-scale image having, for example, 256 levels (that is, 2⁸ represented by 8 bits) in which the color is closer to black as the forward distance from the cleaning apparatus 10 (that is, the cleaning apparatus main body 20) increases, and the color is closer to white as the forward distance decreases. That is, the distance image is an image in which the aggregate of distance data of objects located in front of the cleaning apparatus 10 (that is, the cleaning apparatus main body 20) in the movement direction within an area for which images are captured by the paired cameras 92 is visualized.

The determination unit 465 determines whether objects detected by the obstacle detecting sensor 71 are obstacles on the basis of data of images captured by the paired cameras 92 and the forms of the objects and the distances to the objects obtained by the obstacle detecting sensor 71. Specifically, the determination unit 465 extracts a portion in a predetermined area, for example, in a predetermined rectangular image area in the distance image on the basis of data of images captured by the paired cameras 92 and the forms of the objects and the distances to the objects obtained by the obstacle detecting sensor 71. Subsequently, the determination unit 465 compares the distances to objects within the extracted image area with a set distance that is a predetermined threshold or a variably set threshold. Subsequently, the determination unit 465 determines an object that is located at a distance equal to or shorter than the set distance as an obstacle. In other words, the determination unit 465 determines an object for which the distance from the cleaning apparatus 10 (that is, the cleaning apparatus main body 20) is equal to or shorter than the set distance as an obstacle. The image area is set in accordance with the size of the cleaning apparatus 10 (that is, the cleaning apparatus main body 20) in the up-down direction and in the right-left direction. That is, the size of the image area in the up-down direction and that in the right-left direction are set so as to correspond to an area with which the cleaning apparatus 10 (that is, the cleaning apparatus main body 20) comes into contact when the cleaning apparatus 10 (that is, the cleaning apparatus main body 20) moves straight forward.

The travel control unit 466 controls the magnitudes and orientations of the currents that flow through the paired movement motors 31 to thereby rotate each of the paired movement motors 31 in the forward direction or in the backward direction. The travel control unit 466 thus controls driving of each of the paired movement motors 31 to control driving of each of the paired wheels 33.

The cleaning control unit 467 controls the conduction angle for each of the electric fan 51 and the brush driving motor 41 to thereby control driving of the electric fan 51 and the brush driving motor 41. The cleaning control unit 467 may be provided for each of the electric fan 51 and the brush driving motor 41 separately.

The image-capture control unit 468 includes a control circuit that controls the operations of the shutter of each of the paired cameras 92. The image-capture control unit 468 controls the respective shutters so as to be operated at predetermined time intervals, thereby controlling the paired cameras 92 to capture images at the predetermined time intervals.

### Displays 417c and 417d

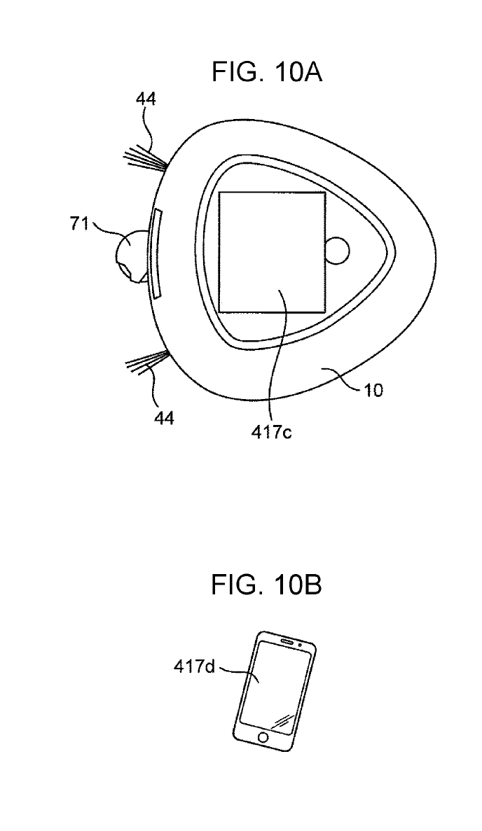

As illustrated in FIG. 10A, a display 417c is disposed on the cleaning apparatus main body 20.

Instead of or in addition to the display 417c disposed on the cleaning apparatus main body 20, display content may be displayed on a display 417d of an external terminal, such as a smartphone, as illustrated in FIG. 10B.

The displays 417c and 417d can function as an example of an input/output device. Specifically, for example, the displays 417c and 417d are liquid crystal displays or organic electroluminescence (EL) displays, and the surface thereof is constituted by a touch panel. Therefore, various display screens can be displayed on the displays 417c and 417d, and user input can be accepted on the displays 417c and 471d.

### Power Supply Unit 80

The power supply unit 80 is located in the cleaning apparatus main body 20 and supplies power to, for example, a communication unit 423, the image capturing unit 425, the drivers 30, the cleaning unit 40, the suction unit 50, and the sensor unit 426. The power supply unit 80 is disposed closer to the back side of the cleaning apparatus main body 20 than the center of gravity G of the cleaning apparatus 10 and closer to the back side of the cleaning apparatus main body 20 than the suction unit 50, and includes elements, such as a power supply case 81. In the first embodiment, specifically, the hardware of the power supply unit 80 includes the power supply case 81, which is fixed to the lower casing 100, the storage battery 82 accommodated in the power supply case 81, and a main switch 83 for switching between supply and stop of power from the power supply unit 80 to each element described above.

As the storage battery 82, for example, a secondary battery is used. The storage battery 82 is accommodated in the cleaning apparatus main body 20 and is electrically connected to charging terminals (not illustrated) that function as connection portions on the respective sides of the back portion on the lower surface of the cleaning apparatus main body 20 so as to be exposed. When the charging terminals are electrically and mechanically connected to a charging device, the storage battery 82 is charged via the charging device.

### Cameras 92

The cleaning apparatus 10 further includes the paired cameras 92 that obtain camera images including information about the surroundings of the cleaning apparatus main body 20 in accordance with image-capture control by the image-capture control unit 468.

The paired cameras 92 constitute the image capturing unit 425 capturing images and are disposed to the right and to the left of the obstacle detecting sensor 71 on the front surface 21 of the cleaning apparatus main body 20. That is, in the first embodiment, the paired cameras 92 are disposed on the front surface 21 of the cleaning apparatus main body 20 to the right and to the left of the center line L in the width direction of the cleaning apparatus 10 (that is, the cleaning apparatus main body 20) at substantially the same predetermined angles (for example, an acute angle) relative to the center line L. In other words, the paired cameras 92 are disposed substantially symmetrically in the width direction of the cleaning apparatus main body 20, and the center position between the paired cameras 92 substantially matches the center position in the width direction that crosses, (for example, is orthogonal to) the front-back direction that is the movement direction of the cleaning apparatus 10 (that is, the cleaning apparatus main body 20). Further, the paired cameras 92 are disposed at substantially the same positions in the up-down direction, that is, at substantially the same heights. Accordingly, in a state where the cleaning apparatus 10 is placed on a floor, the altitudes of the paired cameras 92 from the floor are set to substantially the same altitudes. The paired cameras 92 are disposed away from each other at positions shifted from each other (for example, at positions shifted form each other in the right-left direction). The paired cameras 92 are digital cameras that capture digital images of a front scene in the movement direction of the cleaning apparatus main body 20 at a predetermined horizontal angle of view (for example, 105°) at predetermined time intervals, namely, at very short time intervals of, for example, several tens milliseconds or several seconds. Further, the fields of view of the paired cameras 92 overlap, and the image-capture areas of a pair of images captured by the paired cameras 92 overlap in the right-left direction in an area that includes a front position on the extending center line L, the center line L being a center line in the width direction of the cleaning apparatus 10 (that is, the cleaning apparatus main body 20). In the first embodiment, it is assumed that the paired cameras 92 capture images of, for example, a visible-light area. Images captured by the paired cameras 92 can be compressed in a predetermined data format by, for example, an image processing circuit not illustrated.

Images captured by the paired cameras 92 are input to the image processing unit 463 of the controller 70, and the controller 70 obtains information about objects including the target object 131, such as the presence and forms of the objects.

For example, in the image processing unit 463, when images captured by the cameras 92 are input to a learner in the image processing unit 463 that has performed leaning in advance, object information that includes the presence and forms of objects and name information thereof can be obtained from the camera images. Alternatively, in the image processing unit 463, when matching of patterns (for example, images) retained in advance in the image processing unit 463 with camera images is performed, object information that includes the presence and forms of objects and name information thereof can be obtained.

As described above, in a case where object information is obtained from camera images, the position at a predetermined distance from the own position of the cleaning apparatus 10 in the orientation of the cleaning apparatus 10 (or the cameras 92) when image capturing is performed, that is, the distance between an object and the cleaning apparatus 10, is obtained as the “position of the object”.

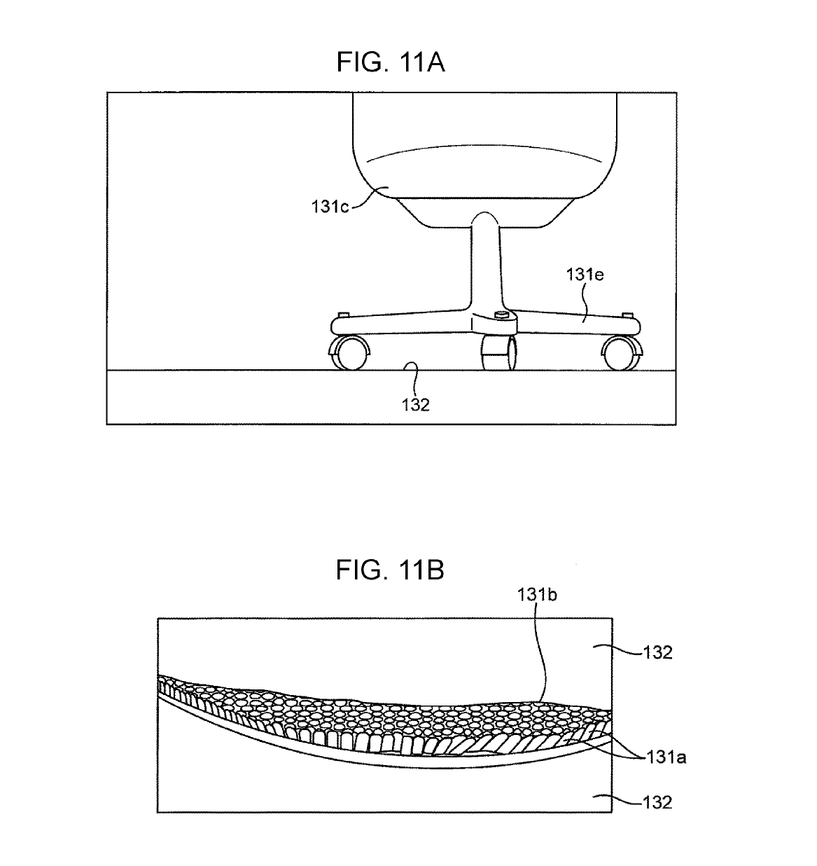

As examples of object information obtained on the basis of camera images, an example of a camera image that includes information about the surroundings of the cleaning apparatus main body, from which information about legs 131e of a chair 131c is obtained, is illustrated in FIG. 11A, and an example from which information about the rug 131b, which is an example of a target object, is obtained is illustrated in FIG. 11B.

### Database 110

The database 110 is connected to, for example, the communication unit 423, the controller 70, the image capturing unit 425, and the sensor unit 426 and includes the map database 99 and a path database 102.

To the map database 99, map information about the cleaning area CA is recorded. As the map information about the cleaning area CA, map information about the cleaning area CA created in advance may be recorded or map information about the cleaning area CA created by the cleaning apparatus 10 may be recorded.

To the path database 102, movement paths P of the cleaning apparatus 10 in the map information about the cleaning area CA are recorded, and information about path generation rules described below is also recorded. Plural movement paths P generated on the basis of path generation rules are recorded in advance to the path database 102, as described below, and a user is allowed to select at least one movement path P from among the movement paths P, and the selection instruction is accepted. Here, the movement paths P are paths along which the cleaning apparatus main body 20 moves and performs cleaning.

### Other Configuration

The cleaning apparatus 10 may further include the communication unit 423 that communicates with an external device 417 constituted by an external terminal device, such as a personal computer (PC) or a smartphone.

The communication unit 423 includes, for example, a wireless local area network (LAN) device 447, a transmission unit not illustrated, and a reception unit not illustrated. The wireless LAN device 447 functions as a wireless communication unit for wireless communication with the external device 417 via a home gateway 414 and a network 415 and as a cleaning-apparatus-signal reception unit. The transmission unit is formed of, for example, an infrared light emitting device and transmits a radio signal (for example, an infrared signal) to, for example, a charging device. The reception unit is formed of, for example, a phototransistor and receives a radio signal (for example, an infrared signal) from, for example, a charging device not illustrated or a remote controller not illustrated.

The wireless LAN device 447 is used to transmit various types of information from the cleaning apparatus 10 to the network 415 via the home gateway 414 and to receive various types of information from the network 415 via the home gateway 414 and, for example, is built in the cleaning apparatus main body 20.

The home gateway 414 is also called, for example, an access point, is installed within a building, and is connected to the network 415 via, for example, a wired line.

A server 416 is a computer (for example, a cloud server) connected to the network 415 and is able to save various types of data.

The external device 417 is a general-purpose device, such as a PC (for example, a tablet terminal (for example, a tablet PC)) 417a or a smartphone (or a mobile phone) 417b, capable of performing wired or wireless communication with the network 415 via, for example, the home gateway 414 within a building and capable of performing wired or wireless communication with the network 415 outside a building.

The external device 417 includes the display 417d (see FIG. 10B) having at least a display function of displaying images.

### First Modification

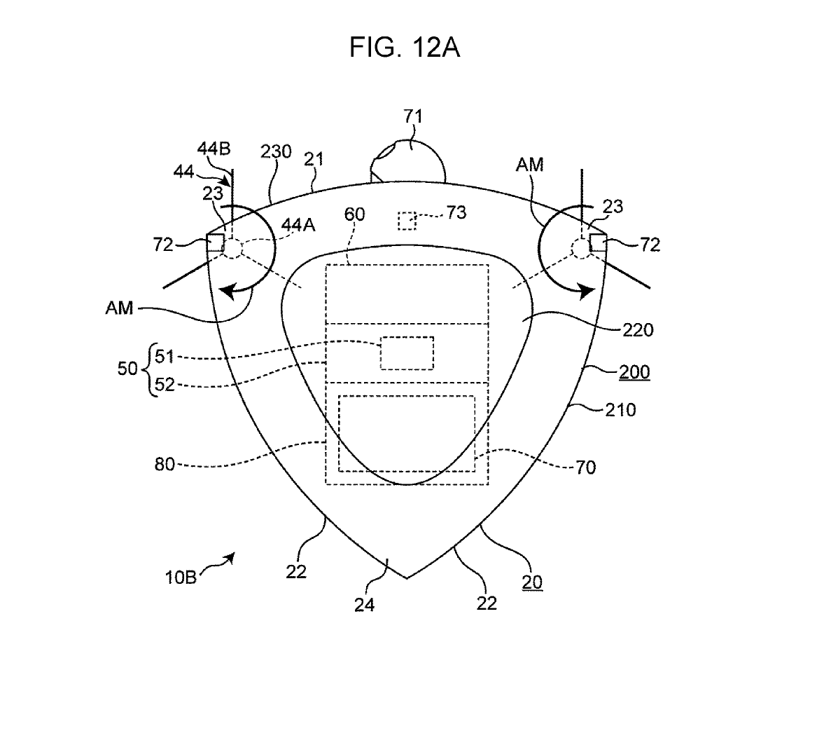

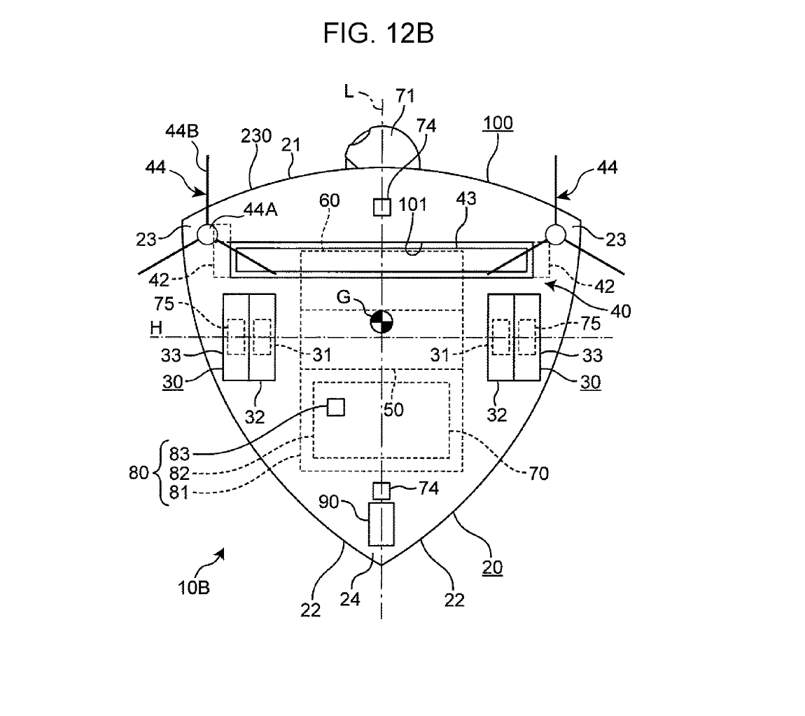

In a cleaning apparatus 10B according to a first modification of the first embodiment illustrated in FIG. 12A and FIG. 12B, the cleaning unit 40 can further include the side brushes 44 that are disposed on the bottom surface side of the lower casing 100 of the cleaning apparatus main body 20, which are not disposed in the cleaning apparatus 10 according to the first embodiment, and the gearbox 42 disposed to the right and to the left of the suction inlet 101. One side brush 44 is provided on the right and left sides of the bottom surface side of the lower casing 100 of the cleaning apparatus main body 20. In the present disclosure, operations in a cleaning method for the cleaning apparatus 10 are construed as operations in a cleaning method for the cleaning apparatus 10B and are applicable to the cleaning apparatus 10B.

One of the gearboxes 42 (for example, the right one in plan view of the cleaning apparatus main body 20) is connected to the output shaft of the brush driving motor 41, the main brush 43, and a corresponding one of the side brushes 44 and transmits a torque of the brush driving motor 41 to the main brush 43 and the corresponding one of the side brushes 44. The other gearbox 42 (for example, the left one in plan view of the cleaning apparatus main body 20) is connected to the main brush 43 and the other side brush 44 and transmits a torque of the main brush 43 to the other side brush 44.

In the first modification of the first embodiment, the paired side brushes 44 each include a brush shaft 44A fixed to a corresponding one of the two front vertex portions 23 of the cleaning apparatus main body 20, and bundles of bristles 44B fixed to the brush shaft 44A. The side brushes 44 are positioned in the cleaning apparatus main body 20 such that part of a locus drawn by each of the side brushes 44, which is capable of collecting dust into the suction inlet 101, rotating (this locus is hereinafter referred to as a rotational locus drawn by the side brush 44 rotating one revolution) is within the maximum-width portion of the cleaning apparatus main body 20. In the first modification of the first embodiment, the number of the bundles of bristles 44B fixed to each brush shaft 44A is three, and the bundles of bristles 44B are fixed to the brush shaft 44A at predetermined angular intervals.

Each brush shaft 44A has a rotation axis that extends in a direction the same as or substantially the same as the height direction of the cleaning apparatus main body 20, is supported by the cleaning apparatus main body 20 so as to be rotatable relative to the cleaning apparatus main body 20, and is disposed closer to the front side of the cleaning apparatus main body 20 than the center line of the suction inlet 101 in the long-side direction.

Each bundle of bristles 44B is formed of plural bristles, and is fixed to a corresponding one of the brush shafts 44A so as to extend in a direction the same as or substantially the same as the radial direction of the brush shaft 44A. In the first modification of the first embodiment, the length of each bundle of bristles 44B are set such that the distal end of the bundle of bristles 44B extends outward beyond the periphery of the cleaning apparatus main body 20.

The rotation direction of each side brush 44 is set to a direction in which the rotational locus of the side brush 44 extends from the front to the back of the cleaning apparatus main body 20 on a side closer to the center of the cleaning apparatus main body 20 in the width direction, as indicated by the arrows AM in FIG. 12A. That is, the side brushes 44 rotate in directions opposite to each other. In the first modification of the first embodiment, each of the side brushes 44 rotates from the front to the back of the cleaning apparatus main body 20 in a portion in which the rotational loci drawn by the respective side brushes 44 come closer to each other.

### Control Method for Cleaning Apparatus 10

Now, a method for controlling the cleaning apparatus 10 by the controller 70 is described.

FIG. 6 is a block diagram illustrating the functions of the electrical system in the cleaning apparatus 10.

The controller 70 is disposed on the power supply unit 80 (see FIG. 1 and FIG. 2) in the cleaning apparatus main body 20 and is electrically connected to the power supply unit 80. Further, the controller 70 is electrically connected to, for example, the communication unit 423, the image capturing unit 425, the sensor unit 426, the paired movement motors 31, the brush driving motor 41, and the electric fan 51.

In the controller 70, the determination unit 465 determines whether an object that can hinder the cleaning apparatus 10 from moving is present within a predetermined area in front of the cleaning apparatus main body 20 on the basis of a detection signal that is input from the obstacle detecting sensor 71 of the sensor unit 426 and that includes the presence and forms of objects and the distances to the objects.

The controller 70 calculates the distances between the periphery of the cleaning apparatus main body 20 and objects present in an area around each of the right and left front vertex portions 23 of the cleaning apparatus main body 20 on the basis of detection signals input from the respective right and left distance measuring sensors 72.

The controller 70 determines whether the cleaning apparatus main body 20 has collided with an object around the cleaning apparatus main body 20 on the basis of a detection signal input from the collision detecting sensor 73.

The controller 70 determines whether a floor surface that is the cleaning area CA is present under the cleaning apparatus main body 20 on the basis of detection signals input from the floor surface detecting sensors 74.

The controller 70 uses one or more of the results of determination and calculation described above to control the movement motors 31, the brush driving motor 41, and the electric fan 51 so that the floor surface that is the cleaning area CA is cleaned by the cleaning apparatus 10.

### Movement Control Method for Cleaning Apparatus 10

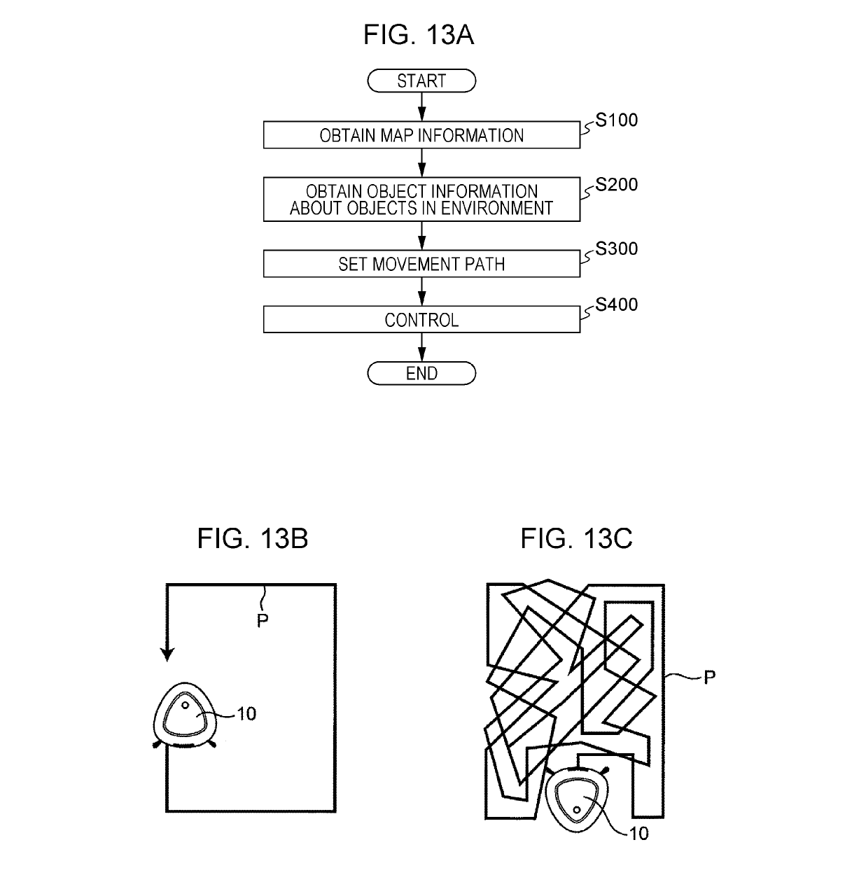

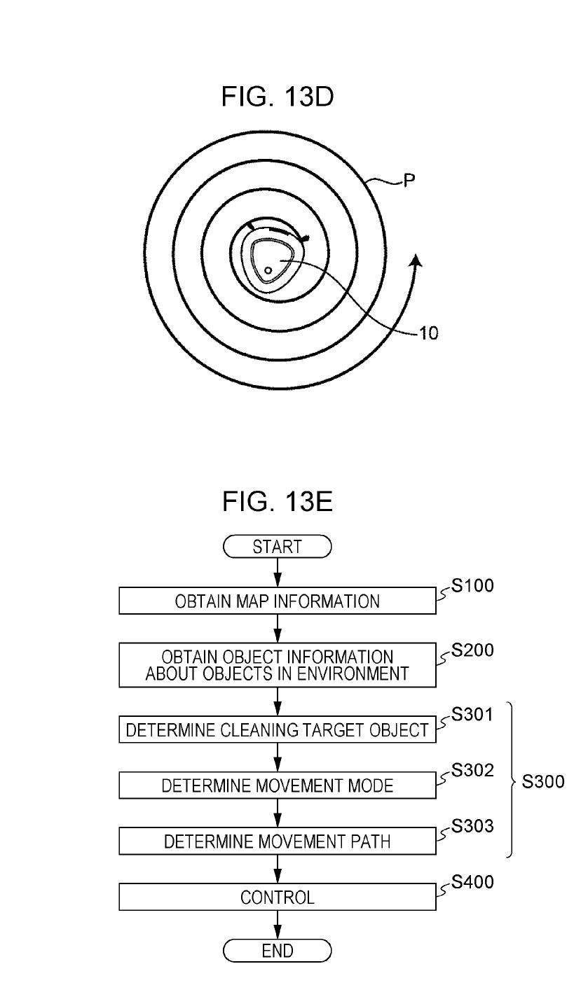

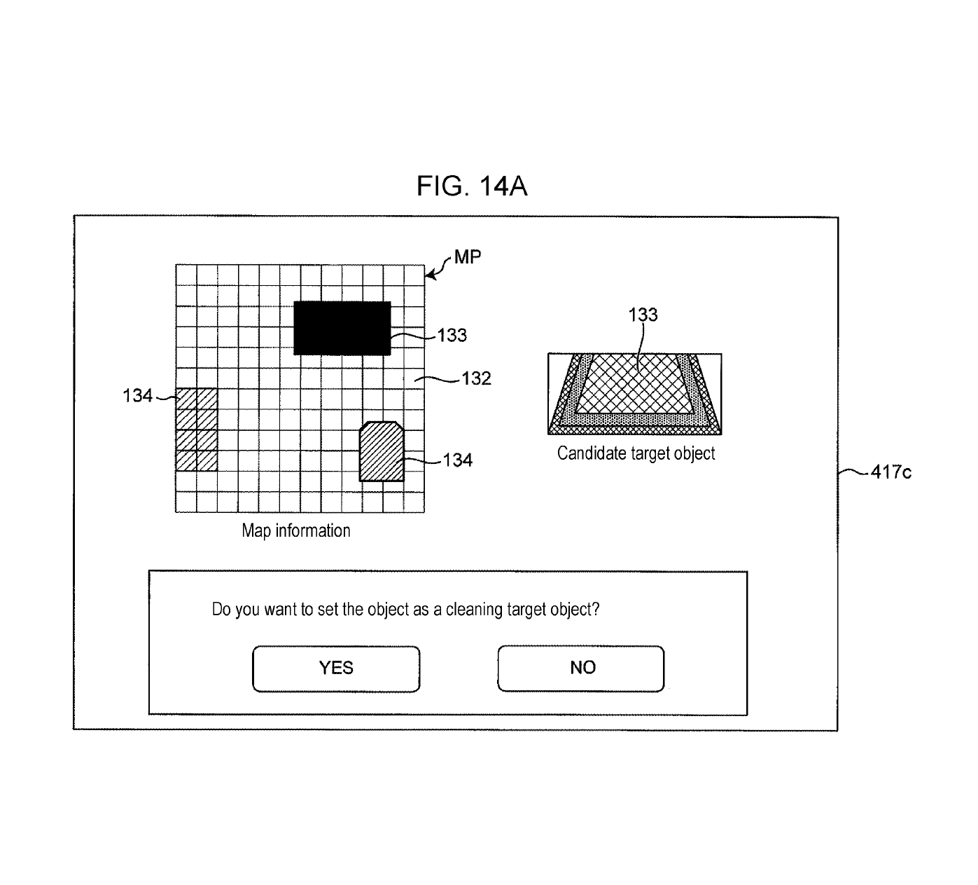

Now, a method for controlling movement of the cleaning apparatus 10 by the controller 70 is described with reference to FIG. 13A.

The movement control method for the cleaning apparatus 10 includes obtaining map information by the controller 70 in step S100, obtaining object information about objects in the environment by the controller 70 in step S200, setting the movement path P by the controller 70 in step S300, and movement control of the cleaning apparatus main body 20 by the controller 70 and driving control of the cleaning unit 40 by the controller 70 in step S400.

Here, the map information is, for example, the two-dimensional map MP illustrated in FIG. 9 and is recorded to the map database 99.

The object information includes at least the positions of objects including a target object on the two-dimensional map MP, camera images or the forms of the objects, and name information about the objects. The object information is recorded to the memory 461. The positions of objects including a target object are recorded to the memory 461 in association with the time of recording. The controller 70 may obtain the map MP that includes the object information and that is associated with the positions of objects from the map database 99 and from the memory 461 as the map information.

### Step S100

The controller 70 obtains map information about the cleaning area CA from the map database 99. FIG. 9 illustrates an example of the map MP of the cleaning area CA, which is an example of the map information. At this time, after the controller 70 has obtained the map information, the cleaning apparatus main body 20 starts moving and performing cleaning while the image processing unit 463 is correcting the map information as necessary by using SLAM. Alternatively, in the cleaning apparatus main body 20, the controller 70 may simply obtain map information created in advance.

### Step S200

In the controller 70, the image processing unit 463 obtains object information about objects within the cleaning area CA from camera images. For example, the rectangle indicated by the reference numeral 131 in FIG. 9 is the target object 131, which is an example object.

Specifically, for example, in the controller 70, the image processing unit 463 obtains object information that includes, for example, the presence and forms of objects within the cleaning area CA and name information thereof from camera images, as illustrated in FIG. 11A and FIG. 11B.

### Step S300

The controller 70 sets a movement path.

Specifically, the controller 70 obtains information about path generation rules from the path database 102.

Subsequently, the controller 70 generates movement paths in the cleaning area CA on the basis of the map information about the cleaning area CA obtained in step S100 and the path generation rules.

Specific examples of generated movement paths P are illustrated in FIG. 13B to FIG. 13D.

In an example path generation rule, the controller 70 controls movement of the cleaning apparatus 10 so that the distance between the cleaning apparatus 10 and a wall of the room detected by the distance measuring sensors 72 is within a predetermined range in the cleaning area CA. With such a path generation rule, a frame-shaped movement path P that goes around along the walls of the room can be generated, as illustrated in FIG. 13B.

In another example path generation rule, the controller 70 controls the cleaning apparatus 10 to randomly move within the cleaning area CA. With such a path generation rule, a random-shaped movement path P can be generated, as illustrated in FIG. 13C.

In another example path generation rule, the controller 70 controls movement of the cleaning apparatus 10 so that the cleaning apparatus 10 moves within the cleaning area CA along a spiral centered on a specified position. With such a path generation rule, a spiral movement path P can be generated, as illustrated in FIG. 13D.

The controller 70 records the generated movement paths P to the path database 102.

Instead of generating the movement paths P as described above, the controller 70 may obtain information about the initial position of the cleaning apparatus main body 20 from the memory 461 and generate the movement paths P in the cleaning area CA on the basis of the information about the initial position, the map information about the cleaning area CA, and the path generation rules.

Here, an example of the information about the initial position is the present position of the cleaning apparatus main body 20 recorded to the memory 461. Here, the present position is the position at which the cleaning apparatus 10 stops when an instruction for cleaning is input to the cleaning apparatus 10.

The controller 70 obtains the present position of the cleaning apparatus main body 20 from the sensor unit 426. Here, as the present position, information about the position of the cleaning apparatus 10 that is moving is obtained. Alternatively, the controller 70 obtains information about the present position of the cleaning apparatus main body 20 from the memory 461 to which information obtained by the sensor unit 426 is recorded. For example, the present position of the cleaning apparatus main body 20 is recorded to the memory 461 in association with the time. The controller 70 obtains from the memory 461 the present position of the cleaning apparatus main body 20 at the latest time recorded to the memory 461 as the initial position.

Another example of the information about the initial position is a position that is determined in advance as the initial position of the cleaning apparatus main body 20 (for example, a position at which charging by a charging device is performed). The controller 70 obtains the information about the initial position of the cleaning apparatus main body 20 from the memory 461.

In a case where the controller 70 uses the information about the initial position to generate the movement paths P in the cleaning area CA for setting, the controller 70 can generate the frame-shaped movement path P, the random-shaped movement path P, and the spiral movement path P described above having the initial position as the starting point and set the movement path P.

### Detailed Process Flow in Step S300

FIG. 13E is a more detailed process flow of generating the movement paths P for setting the movement path P in step S300.

The movement path setting by the controller 70 in step S300 includes accepting setting of a cleaning target object in step S301, accepting a movement mode in step S302, and accepting a movement path in step S303.

The order of steps S301 to S303 is not limited to this. For example, step S302 and step S303 are flipped in the order, or the steps may be performed in the order of steps S303, S301, and S302.

### Step S301

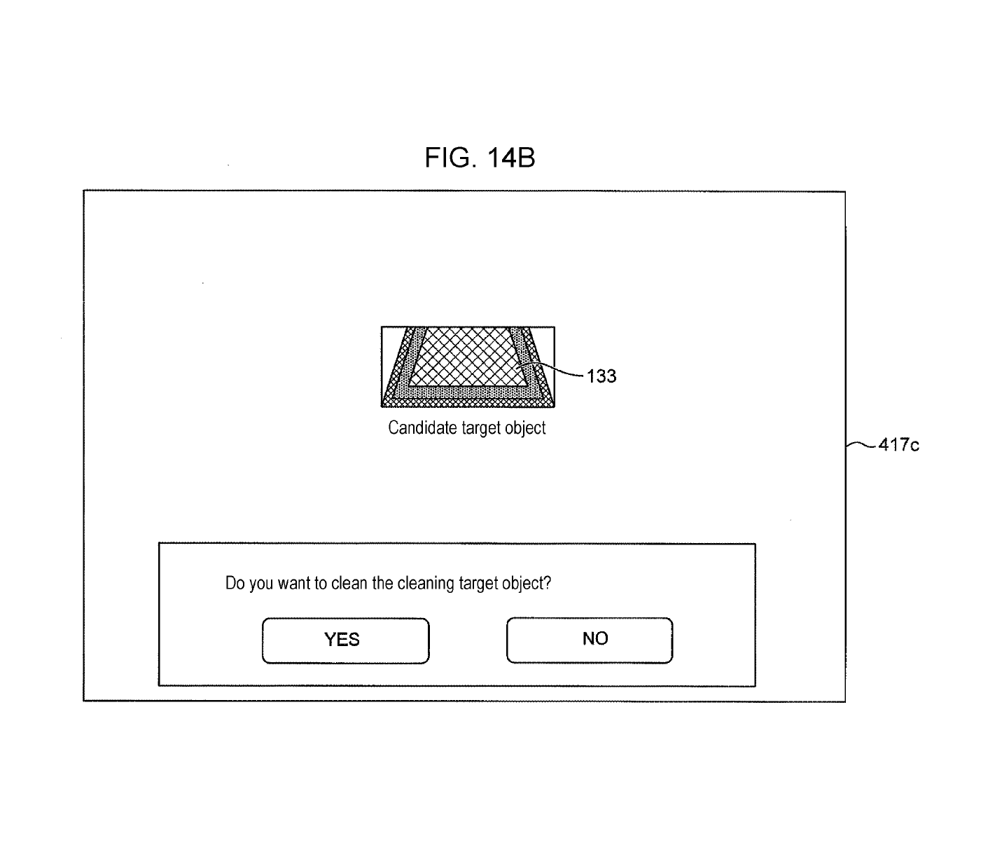

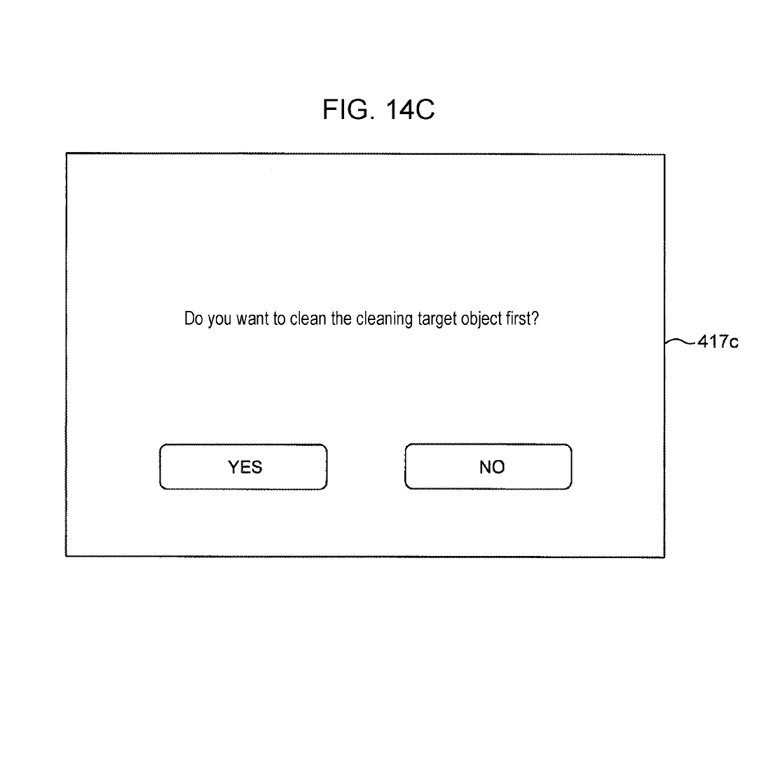

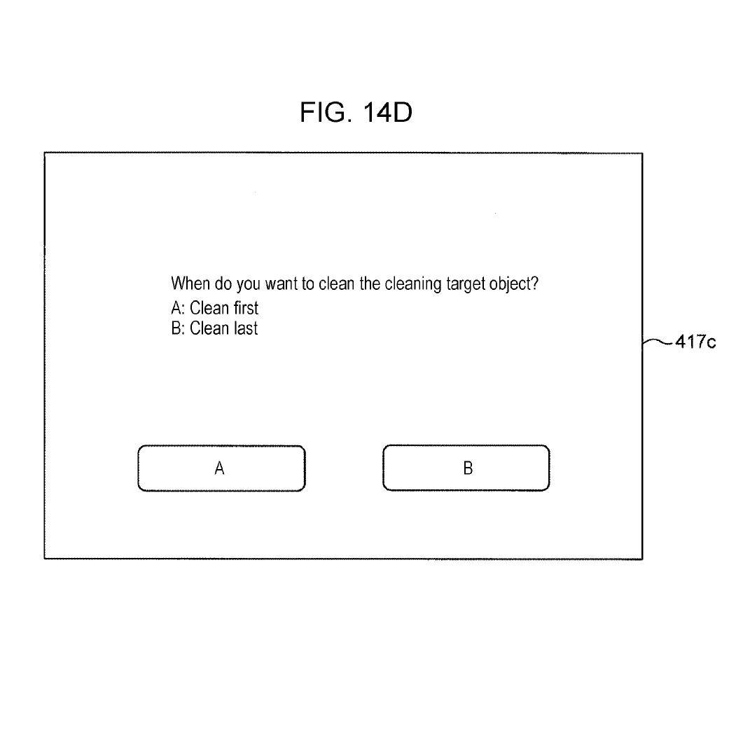

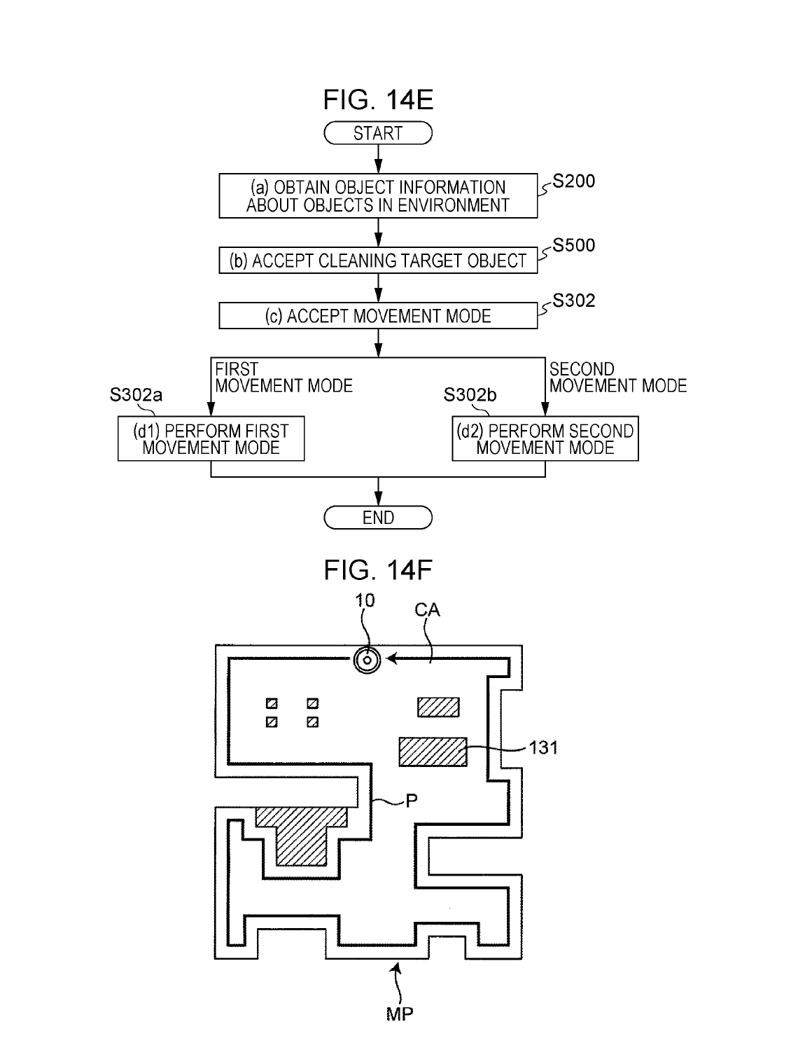

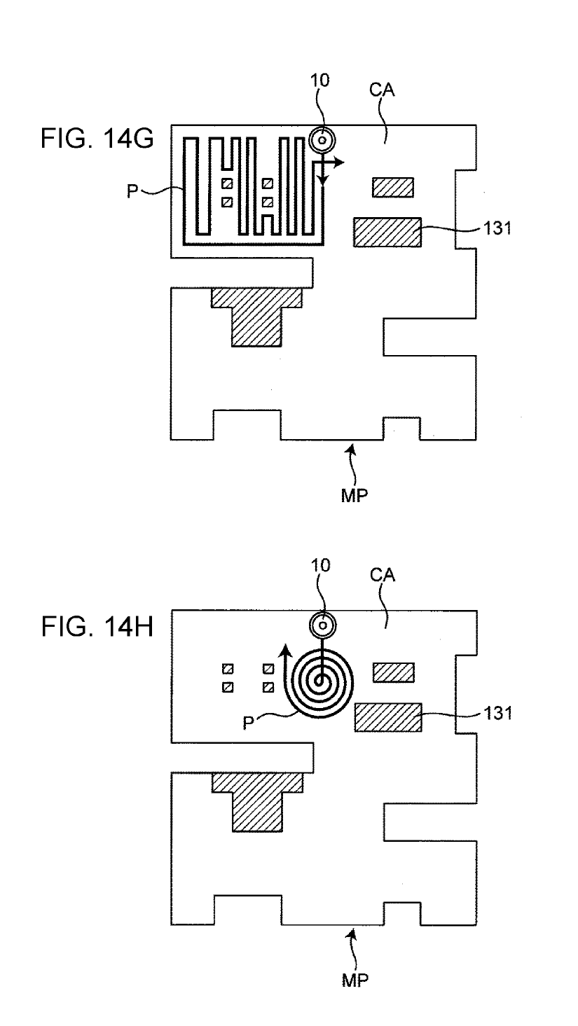

The controller 70 accepts setting of a cleaning target object. Here, the image processing unit 463 of the controller 70 detects objects 133 and 134 from data of images captured by the paired cameras 92. Subsequently, the controller 70 accepts an instruction from a user for selecting whether to set the detected objects 133 and 134 as cleaning target objects. To accept a selection instruction from a user, a display screen illustrated in FIG. 14A may be displayed on the display 417c. The example display screen illustrated in FIG. 14A includes two-dimensional map information, information about an object, and display for accepting a user's selection. The two-dimensional map information illustrated in FIG. 14A includes positional information about the objects 133 and 134 on the map. The information about an object illustrated in FIG. 14A is an image of the object 133. The display for accepting a user's selection illustrated in FIG. 14A is display for prompting the user to select whether to set the object 133, that is, the rectangular rug, as a cleaning target object. The controller 70 accepts the user's selection.

If the user wants to set the object 133 as a cleaning target object, the user presses the YES button. If the user does not want to set the object 133 as a cleaning target object, the user presses the NO button. It is assumed here that the controller 70 accepts a user's selection instruction indicating that the object 133 is to be set as a cleaning target object. That is, the controller 70 accepts a setting indicating that the object 133 is to be set as a cleaning target object.

Similarly, the controller 70 causes the display 417c to display an image of the object 134 and display for prompting the user to select whether to set the object 134 as a cleaning target object (not illustrated). The controller 70 accepts a selection instruction indicating that the object 134 is to be set or is not to be set as a cleaning target object. It is assumed here that the controller 70 accepts a user's selection instruction indicating that the object 134 is not to be set as a cleaning target object. That is, the controller 70 accepts a setting indicating that the object 134 is not to be set as a cleaning target object.

FIG. 14B illustrates another example display screen on the display 417c. FIG. 14B illustrates a case where a user's selection instruction indicating that the object 133 is to be set or is not to be set as a cleaning target object, that is, the object 133 is to be cleaned or is not to be cleaned, is accepted.

If the user wants to set the object 133 as a cleaning target object, the user presses the YES button. If the user does not want to set the object 133 as a cleaning target object, the user presses the NO button. It is assumed here that the controller 70 accepts a selection instruction indicating that the object 133 is to be set as a cleaning target object. That is, the controller 70 accepts a setting indicating that the object 133 is to be set as a cleaning target object, that is, the object 133 is to be cleaned.

In a case where no objects are set as cleaning target objects, step S302 is skipped (not illustrated), and the flow proceeds to step S303.

In a case where the object 133 is set in advance as a cleaning target object, that is, the object 133 is set in advance so as to be cleaned, accepting user's selection indicating that the object 133 is to be cleaned or is not to be cleaned is not necessary. For example, a setting indicating that the object 133 is to be set as a cleaning target object may be set on the basis of the item type of the object 133.

### Step S302

Subsequently, the controller 70 accepts a movement mode. An example display screen on the display 417c illustrated in FIG. 14C illustrates a case where a user's selection instruction indicating that the object 133 that is a cleaning target object is to be cleaned or is not to be cleaned first is accepted.

If the user wants to clean the object 133 that is a cleaning target object first, the user presses the YES button. If the user does not want to clean the object 133 that is a cleaning target object first, the user presses the NO button. At this time, the example display screen on the display 417c illustrated in FIG. 14C includes a question asking “do you want to clean the cleaning target object first?” and the buttons YES and NO. It is assumed here that the controller 70 accepts a selection instruction indicating that the object 133 that is a cleaning target object is to be cleaned first in a state where the display screen illustrated in FIG. 14C is displayed.

FIG. 14D illustrates another example display screen on the display 417c. The example display screen on the display 417c illustrated in FIG. 14D includes a question asking “when do you want to clean the cleaning target object?”, descriptions of the options A “clean first” and B “clean last”, and the buttons A and B. FIG. 14D illustrates a case of accepting a user's selection instruction indicating A “the object 133 that is a cleaning target object is to be cleaned first” or B “the object 133 that is a cleaning target object is to be cleaned last” in the case where the object 133 that is a cleaning target object is to be cleaned.

If the user wants to clean the object 133 that is a cleaning target object first, the user presses the A button. If the user wants to clean the object 133 that is a cleaning target object last, the user presses the B button. It is assumed here that the controller 70 accepts a user's selection instruction indicating that the object 133 that is a cleaning target object is to be cleaned first.

Selecting the option of cleaning the object 133 first in FIG. 14C means selecting the second movement mode recorded to the memory 461. Selecting the option A of cleaning the object 133 first in FIG. 14D means selecting the second movement mode recorded to the memory 461. Selecting the option of not cleaning the object 133 first in FIG. 14C means selecting the first movement mode recorded to the memory 461. Selecting the option B of cleaning the object 133 last in FIG. 14D means selecting the first movement mode recorded to the memory 461.

### Step S303

Subsequently, the controller 70 accepts a movement path. For example, the user selects one movement path P from among the frame-shaped movement path P, the random-shaped movement path P, and the spiral movement path P described above having the initial position as the starting point. The controller 70 accepts the user's selection. Examples of the accepted movement path are illustrated in FIG. 14F to FIG. 14H. FIG. 14F illustrates a case where the frame-shaped movement path P illustrated in FIG. 13B is accepted for the cleaning area CA illustrated in FIG. 9. FIG. 14G illustrates a case where the random-shaped movement path P illustrated in FIG. 13C is accepted for the cleaning area CA illustrated in FIG. 9. FIG. 14H illustrates a case where the spiral movement path P illustrated in FIG. 13D is accepted for the cleaning area CA illustrated in FIG. 9. The controller 70 accepts one movement path P from among the three movement paths P illustrated in FIG. 14F to FIG. 14H.

### Step S400

Subsequently, in the controller 70, the travel control unit 466 controls the drivers 30 to move the cleaning apparatus main body 20 along the selected movement path P from the initial position as the starting point. While the cleaning apparatus main body 20 is moving along the movement path P, in the controller 70, the cleaning control unit 467 drives the cleaning unit 40 to clean the cleaning area CA.

At this time, the controller 70 obtains positional information about the cleaning apparatus main body 20 from data of images captured by the paired cameras 92. The controller 70 obtains the present position of the cleaning apparatus main body 20 on the map MP of the cleaning area CA on the basis of the obtained positional information about the cleaning apparatus main body 20 and the map MP of the cleaning area CA in the map database 99.

That is, the controller 70 obtains, as positional information about the cleaning apparatus main body 20, the initial position of the cleaning apparatus main body 20 from data of images captured by the paired cameras 92. In the controller 70, the computation unit 469 performs calculation from the numbers of revolutions detected by the number-of-revolutions sensor 455 by using odometry to obtain information about the amount of movement by the drivers 30 of the cleaning apparatus main body 20 from the initial position. The obtained initial position and amount of movement can be recorded to the memory 461 or to the map database 99.

Accordingly, the computation unit 469 adds the amount of movement of the cleaning apparatus main body 20 to the initial position of the cleaning apparatus main body 20 to thereby obtain the present position of the cleaning apparatus main body 20 that is moving.

For example, the controller 70 may record the present position of the cleaning apparatus main body 20 to the map MP of the cleaning area CA in the map database 99. The controller 70 can record the present position of the cleaning apparatus main body 20 to the map MP in the map database 99 at predetermined time intervals.

In the controller 70, the travel control unit 466 controls driving of the drivers 30 to move the cleaning apparatus main body 20 so that the movement locus of the present position of the cleaning apparatus main body 20 matches the selected movement path P. Accordingly, the controller 70 can move the cleaning apparatus main body 20 along the selected movement path P from the initial position as the starting point by the travel control unit 466 controlling the drivers 30.

### Minimum-Configured Steps

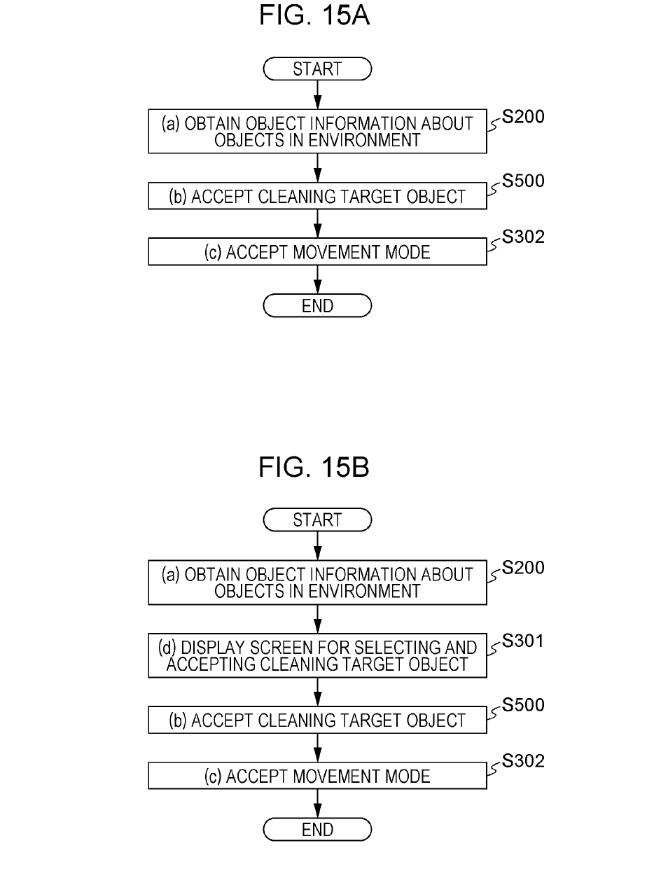

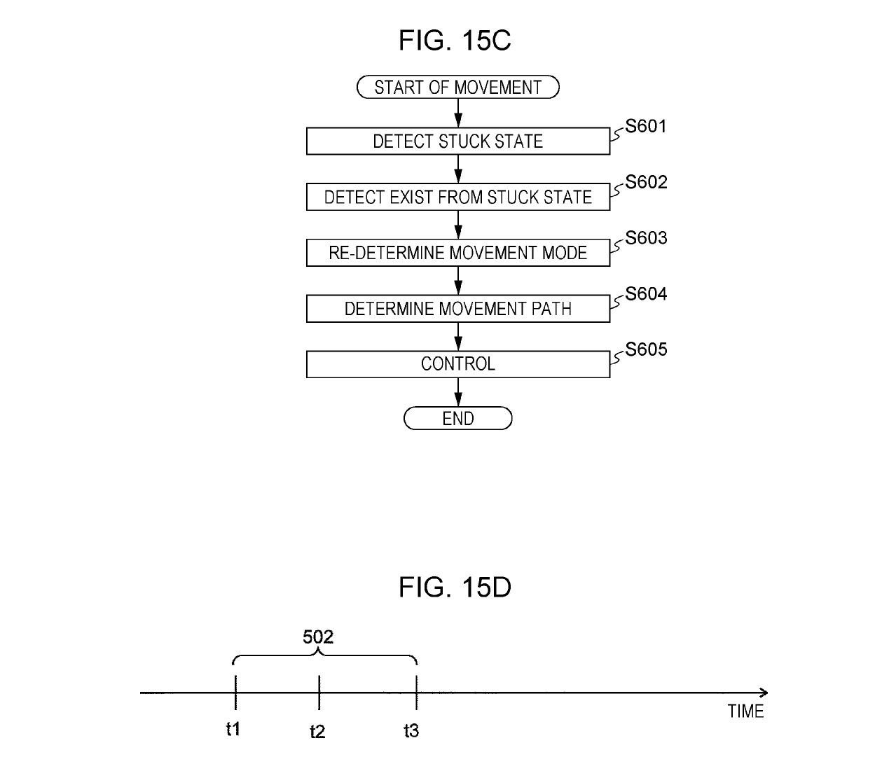

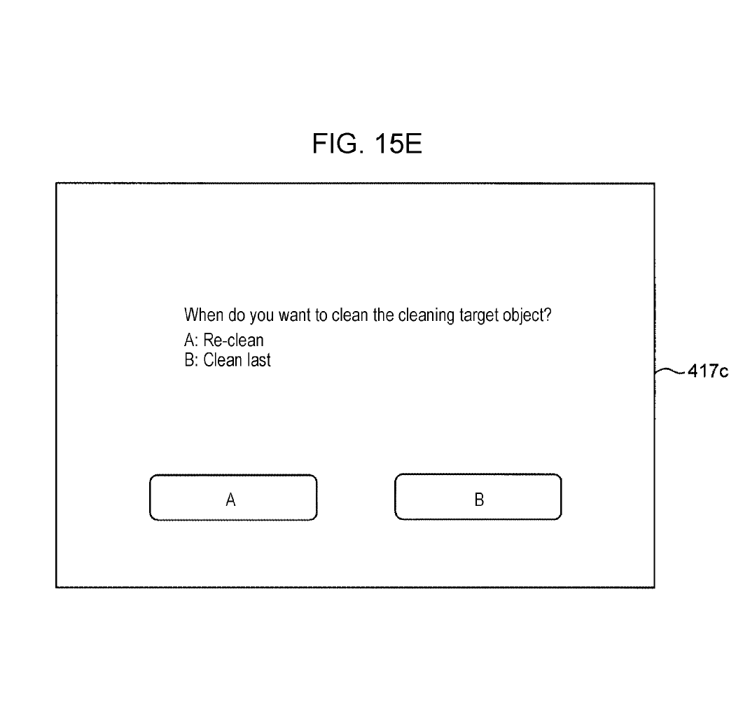

Although the overall operations of the cleaning apparatus 10 have been described above, all of the steps are not necessary in the first embodiment. Now, minimum-configured steps in the first embodiment are described with reference to FIG. 15A.

The cleaning method that is performed by the cleaning apparatus 10 can be constituted by at least the following operations, namely, obtaining object information about objects in the environment by the controller 70 in step S200, accepting a cleaning target object by the controller 70 in step S500, and accepting a movement mode by the controller 70 in step S302.

### Step S200

First, the image processing unit 463 (a) obtains information about the object 133 within the cleaning area CA. That is, as described above, in the controller 70, the image processing unit 463 obtains object information about objects within the cleaning area CA from camera images. Here, the object 133 is a target object having a possibility of putting the cleaning apparatus main body 20 into a stuck state. Specifically, information indicating that the object 133 is an object that put the cleaning apparatus main body 20 into a stuck state in the past is recorded to the memory 461 or to the map database 99. Information indicating that the object 133 is an object having a predetermined height or more may be recorded to the memory 461 or to the map database 99. Alternatively, information indicating that the object 133 is a rug that is laid on a floor, which may be a carpet, may be recorded to the memory 461 or to the map database 99. Information indicating that the object 133 is an object that is set in advance by a user as a target object having a possibility of creating a stuck state may be recorded to the memory 461.

### Step S500

Next, the controller 70 (b) accepts information about setting of a cleaning target object indicating that the object 133 is to be set or is not to be set as a cleaning target object. In a specific example of accepting, the operation in step S301 described above and illustrated in FIG. 14A is performed as mentioned in a second modification below. Alternatively, the controller 70 may accept setting of a cleaning target object on the basis of a user's spoken instruction. For example, the memory 461 retains information in which the cleaning target object is associated with audio data. The controller 70 may compare the user's spoken instruction with the audio data recorded to the memory 461 to thereby accept information about setting of the cleaning target object.

### Step S302

Next, the controller 70 (c) accepts information indicating the time when the object 133 that is a cleaning target object is to be cleaned, as illustrated in FIG. 14D. A description is given of an example case of cleaning the cleaning area CA.

The controller 70 causes the display 417c or 417d to display a first display screen that allows selection of (i) the first movement mode in which the cleaning apparatus 10 cleans the cleaning area CA except for the object 133 that is a cleaning target object, and thereafter, cleans the object 133 that is a cleaning target object while climbing over the object 133 or (ii) the second movement mode in which the cleaning apparatus 10 cleans the object 133 that is a cleaning target object first while climbing over the object 133, and thereafter, cleans the cleaning area CA except for the object 133 that is a cleaning target object.

In a case where the controller 70 accepts information indicating that the object 133 is not to be set as a cleaning target object, cleaning ends when the cleaning apparatus 10 finishes cleaning the cleaning area CA except for the object 133 and, for example, the cleaning apparatus 10 returns to the reference position.

With the cleaning apparatus and the cleaning method thus configured according to the first embodiment, movement modes that take into consideration the order of cleaning of the object 133 having a possibility of creating a stuck state and cleaning of a portion other than the object 133 can be generated and provided to a user.

### Second Modification

As the second modification of the first embodiment, the following operations are performed.

Specifically, as illustrated in FIG. 15B, between the operation (a) in step S200 and the operation (b) in step S500 described above, the controller 70 (d) causes the display 417c or 417d to display a second display screen (see FIG. 14B) that allows selection of whether to set the object 133 as a cleaning target object similarly to the operation in step S301 described above and illustrated in FIG. 14B.

Subsequently, in a state where the second display screen is displayed on the display 417c or 417d, as illustrated in FIG. 14B, the controller 70 accepts information indicating that the object 133 is to be set or is not to be set as a cleaning target object in the operation (b) in step S500 described above to thereby perform an operation of accepting the cleaning target object.

### Third Modification

As a third modification of the first embodiment, as illustrated in FIG. 14E, the following operations are performed.

Specifically, in a case where the controller 70 (d1) accepts selection of the first movement mode in a state where the first display screen as illustrated in FIG. 14D is displayed on the display 417c or 417d, the travel control unit 466 controls the cleaning apparatus main body 20 to move in accordance with the first movement mode in step S302a.

On the other hand, in a case where the controller 70 (d2) accepts selection of the second movement mode in the state where the first display screen as illustrated in FIG. 14D is displayed on the display 417c or 417d, the travel control unit 466 controls the cleaning apparatus main body 20 to move in accordance with the second movement mode in step S302b.

### Fourth Modification of First Embodiment

### Stuck State

While the cleaning apparatus 10 is cleaning the object 133 that is a cleaning target object, depending on the object 133, the cleaning apparatus 10 has a possibility of entering a stuck state as illustrated in FIGS. 7A to 7C and FIGS. 8A and 8B in the movement operation in step S302a or S302b after step S302 described above. A movement control method in the case where the cleaning apparatus 10 enters a stuck state is described.

As illustrated in FIG. 15C, the movement control method that is performed by the controller 70 at this time is constituted by the following operations, namely, detecting a stuck state in step S601, detecting an exit from the stuck state in step S602, re-determining a movement mode in step S603, determining a movement path in step S604, and controlling in step S605.

### Step S601

First, detection of a stuck state by the controller 70 in step S601 is described.

The controller 70 can detect the movement motors 31 stopping rotating or substantially stopping rotating when the numbers of revolutions detected by the number-of-revolutions sensor 455 become 0 or close to 0. The controller 70 detects the state where the movement motors 31 stop rotating or substantially stop rotating to thereby detect the cleaning apparatus 10 entering a stuck state. Here, the number-of-revolutions sensor 455 functions as an example of a second sensor.

In this case, the following is assumed. As illustrated in FIG. 15D, the cleaning apparatus 10 approaches the rug 131b that is an example of a cleaning target object at time t1 (see FIG. 7A and FIG. 11B). Subsequently, the cleaning apparatus 10 is about to climb onto an edge of the rug 131b and is stuck at time t2 (see FIG. 7B and FIG. 7C). Subsequently, the controller 70 detects the cleaning apparatus 10 entering a stuck state at time t3.

In the controller 70, the image processing unit 463 obtains a camera image at a time (which is assumed to be time t1 here) a predetermined period (for example, several seconds) before time t3 at which the stuck state is detected, the predetermined period being indicated by the reference numeral 502. In the camera image at time t1, the cleaning target object that has created the stuck state is to be present. That is, in the camera image at time t1, the rug 131b in front of the cleaning apparatus 10 is present such that the rug 131b is away from the cleaning apparatus 10 in the movement direction, as illustrated in, for example, FIG. 11B. At time t2 between time t1 and time t3, the cleaning apparatus 10 climbs onto an edge of the rug 131b and enters a stuck state, as illustrated in FIG. 7B and FIG. 7C, and therefore, the camera image at time t3 is substantially the same as the camera image at time t2.

In the controller 70, the image processing unit 463 compares the camera image at time t3 with the camera image at time t1, and the controller 70 assumes that the rug 131b is a cleaning target that has created the stuck state and identifies the position and form of the rug 131b. That is, the controller 70 obtains information about the object 133 on the basis of information about the stuck state of the cleaning apparatus main body 20 detected by the number-of-revolutions sensor 455.

### Step S602

Next, detection of an exit from the stuck state by the controller 70 in step S602 is performed as follows. In a case where the cleaning apparatus 10 enters a stuck state due to the rug 131b, for example, the user needs to pick up the cleaning apparatus 10 off the rug 131b and place the cleaning apparatus 10 at a separate position. At this time, when the cleaning apparatus 10 is picked up off the rug 131b or the floor 132, coming-off detecting switches 75 of the cleaning apparatus 10 operate, and the movement of the cleaning apparatus 10 is stopped.

Specifically, as illustrated in FIG. 2, in the upper portion of the wheel house of each wheel 33, the coming-off detecting switch 75 is fixed. The coming-off detecting switches 75 constitute part of the sensor unit 426. When the drivers 30 come off the floor 132, the coming-off detecting switches 75 are each pushed by a spring unit not illustrated. Each coming-off detecting switch 75 usually detects a spring of the spring unit pushing the corresponding wheel 33 against the floor 132 with a force exerted by the spring. Therefore, the coming-off detecting switch 75 detecting a force against the exerted force of the spring being lost means that the cleaning apparatus 10 has come off the floor or the user has picked up the cleaning apparatus 10 off the floor, and therefore, the coming-off detecting switch 75 outputs a signal to the controller 70. In response to the signal, the controller 70 stops the movement of the cleaning apparatus 10. At this time, the controller 70 receives the signal to thereby detect the cleaning apparatus main body 20 exiting the stuck state.

### Step S603

Next, in re-determination of a movement mode by the controller 70 in step S603, the user is prompted to select the time when the object 133 that is a cleaning target object and that has created the stuck state is to be cleaned on the display screen on the display 417c as illustrated in FIG. 15E, and the controller 70 accepts the selection instruction. That is, FIG. 15E illustrates a case where the user is prompted to select A “re-clean the cleaning target object 133 first” or B “clean the cleaning target object 133 last”, and the controller 70 accepts the selection instruction.

Selection of A “re-clean the object 133 that is a cleaning target object first” on the screen illustrated in FIG. 15E means re-selecting the second movement mode recorded to the memory 461. Selection of “clean the object 133 that is a cleaning target object last” on the screen illustrated in FIG. 15E means selecting the first movement mode recorded to the memory 461.

In the re-determination of a movement mode in step S603, the controller 70 may automatically select the second movement mode to re-clean the object 133 first without prompting the user to make selection and accepting the selection instruction (not illustrated).

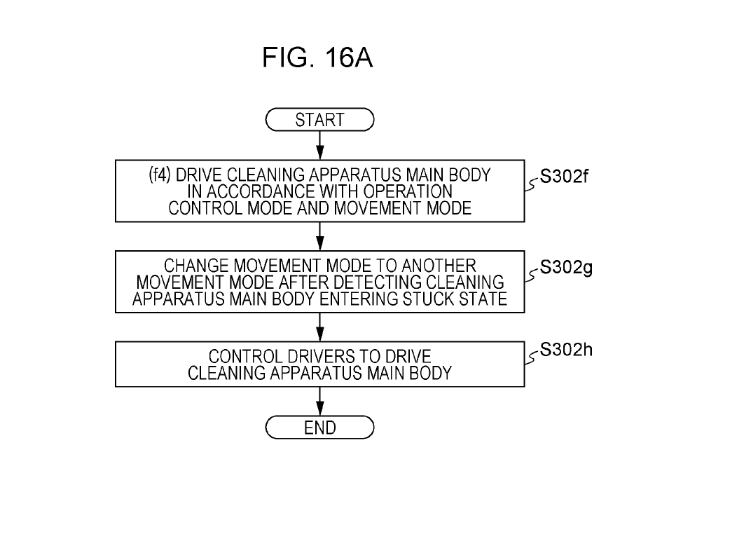

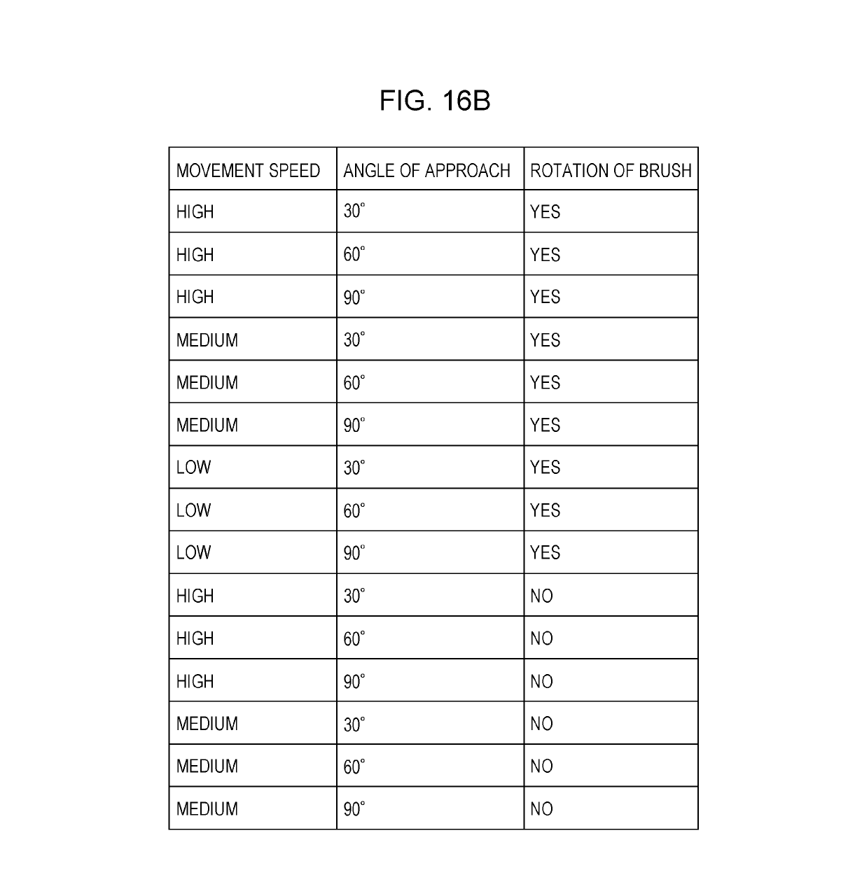

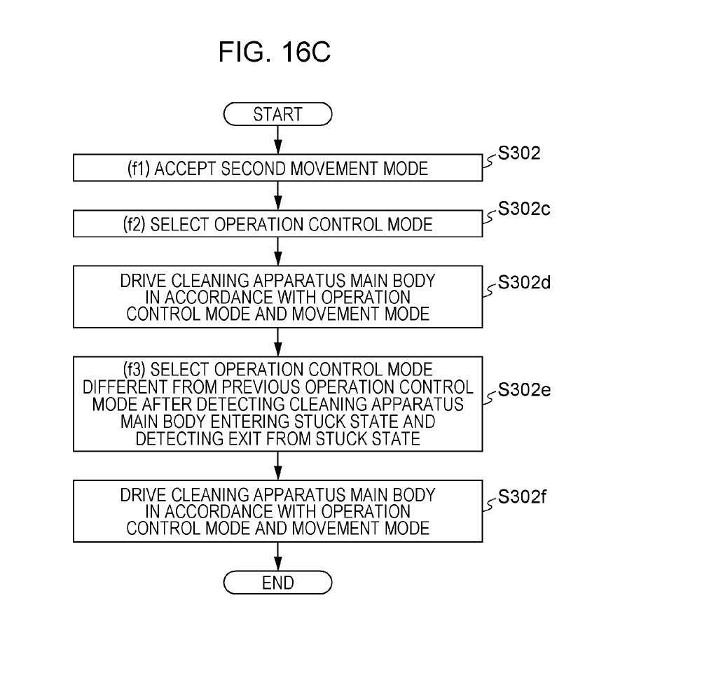

As described below with reference to FIG. 16A, in a case where the cleaning apparatus 10 moves in the second movement mode first and enters a stuck state, the controller 70 may automatically select the first movement mode to re-clean the object 133 last.

In the re-determination of a movement mode in step S603, the following operations may be further performed.

In a case where the object 133 that has created a stuck state is to be re-cleaned, cleaning at the same speed in the same direction is highly likely to create a stuck state again. Therefore, the controller 70 uses an operation control mode in which at least one of an increase in the movement speed, a change in the angle of approach (for example, 45 degrees) relative to an edge of the object 133, and rotation stop of the side brushes 44 is selected to change the operation. FIG. 16B illustrates example operation control modes, and one of the operation control modes is used simultaneously with the first movement mode or the second movement mode.

That is, for example, when the movement speed is set to the movement speed “high” that is higher than the movement speed “medium”, which is a speed in usual cleaning, the cleaning apparatus 10 might not enter a stuck state at an edge of the object 133 and may be able to swiftly run across the edge of the object 133. When the cleaning apparatus 10 moves and approaches an edge of the object 133 in a diagonal direction at the angle of approach set to 30 degrees or 60 degrees instead of 90 degrees, which is an angle in a usual case, the cleaning apparatus 10 may be able to climb over the edge of the object 133, as illustrated in FIGS. 7D and 7E and FIG. 8C. When rotation of the side brushes 44 is stopped, the side brushes 44 might not catch in the threads 131a of the rug 131b, and the cleaning apparatus 10 may be able to climb over an edge of the object 133.

The controller 70 may automatically select one of the operation control modes illustrated in FIG. 16B. Alternatively, candidate operation control modes for selection may be displayed on the display 417c or 417d, and thereafter, the user may make a selection and the controller 70 may accept the selection instruction, as in the selection of the first movement mode or the second movement mode.

After step S302 in the operation described above, the following operations can be performed, as illustrated in FIG. 16C.

(f1) In step S302, the controller 70 accepts selection of the second movement mode in a state where the first display screen is displayed.

(f2) Subsequently, in step S302c, the controller 70 selects one operation control mode from among the operation control modes as a first operation control mode.

Subsequently, in step S302d, in the controller 70, the travel control unit 466 controls the drivers 30 to drive the cleaning apparatus main body 20 in accordance with the first operation control mode and the second movement mode.

(f3) Subsequently, in step S302e, in a case where the number-of-revolutions sensor 455 detects the cleaning apparatus main body 20 entering a stuck state, and thereafter, the coming-off detecting switches 75 detect the cleaning apparatus main body 20 exiting the stuck state, the controller 70 selects an operation control mode different from the first operation control mode from among the operation control modes as a second operation control mode.

Subsequently, in step S302f, in the controller 70, the travel control unit 466 controls the drivers 30 to drive the cleaning apparatus main body 20 in accordance with the second operation control mode and the second movement mode.

Here, the second operation control mode is different from the first operation control mode in the movement speed, the movement direction, or rotation or stop of the side brushes 44 of the cleaning apparatus main body 20.

After step S302f in the operation described above, the following operations can be performed, as illustrated in FIG. 16A.

(f4) In step S302f, the controller 70 drives the cleaning apparatus main body 20 in accordance with the second operation control mode and the second movement mode.

Subsequently, in step S302g, in a case where the controller 70 detects the cleaning apparatus main body 20 entering a stuck state on the basis of a detection value obtained by the number-of-revolutions sensor 455, the controller 70 changes the second movement mode to the first movement mode.

Subsequently, in step S302h, the controller 70 may control the drivers 30 to drive the cleaning apparatus main body 20.

### Step S604

Subsequently, determination of a movement path by the controller 70 in step S604 is performed similarly to step S300.

### Step S605

Subsequently, control by the controller 70 in step S605 is performed similarly to step S400.

According to the embodiment described above, movement modes that take into consideration an order of cleaning of the object 133 having a possibility of creating a stuck state and cleaning of a portion other than the object 133 can be generated and provided to a user.

The present disclosure has been described with reference to the embodiment and modifications described above; however, the present disclosure is not limited to the embodiment and modifications described above, as a matter of course. The following cases are included in the present disclosure.

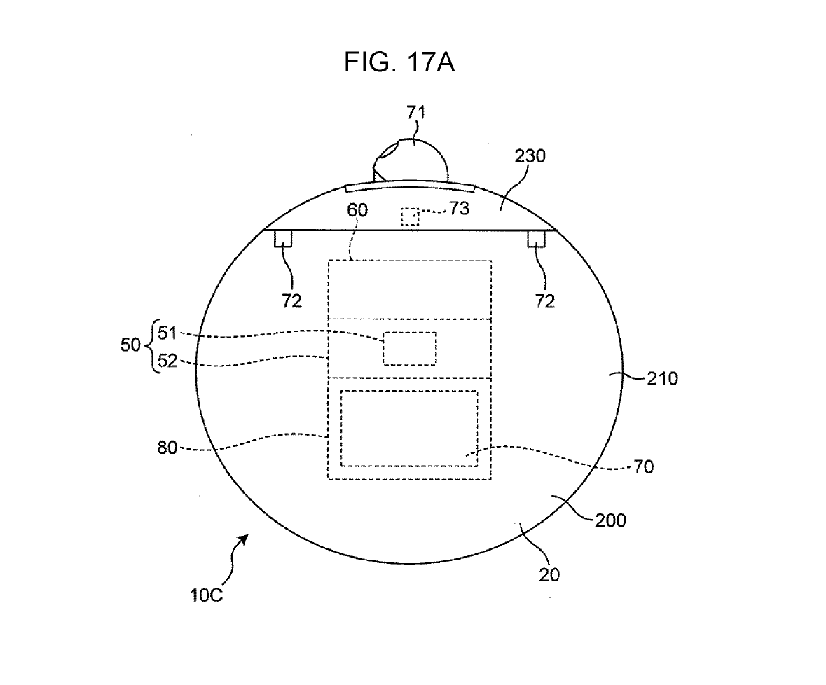

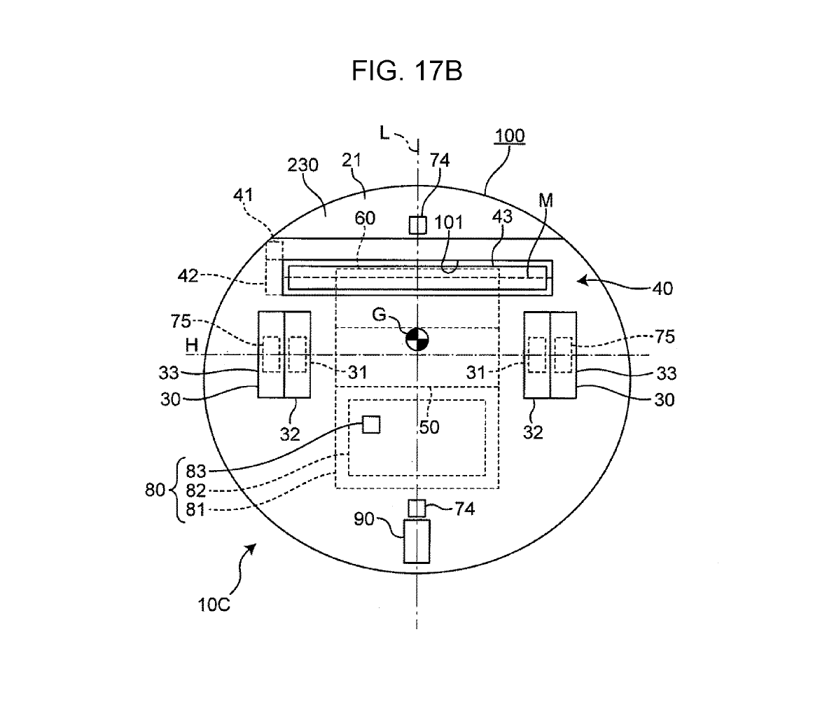

In the embodiment or modifications of the present disclosure, the planar shape of the cleaning apparatus 10 is not limited to a Reuleaux triangle or a Reuleaux polygon, and may be a round shape as indicated by a cleaning apparatus 100 illustrated in FIG. 17A and FIG. 17B.

Specifically, the controller 70 is, in part or in whole, a computer system constituted by, for example, a microprocessor, a ROM, a RAM, a hard disk unit, a display unit, a keyboard, and a mouse. To the RAM or the hard disk unit, a computer program is recorded. When the microprocessor operates in accordance with the computer program, the function of each unit is implemented. The computer program is composed of instruction codes each indicating an instruction to be given to the computer for implementing a predetermined function.

For example, a program executing unit, such as a CPU, can read and execute a software program recorded to a recording medium, such as a hard disk or a semiconductor memory, to thereby implement each constituent element. Software for implementing some or all of the elements constituting the controller 70 in the embodiment or modifications described above is a program for causing a computer to perform a cleaning method for an autonomous mobile cleaning apparatus, the method including: (a) obtaining information about a first target object having a possibility of putting a main body included in the autonomous mobile cleaning apparatus into a stuck state, the main body including a suction unit; and (b) accepting information indicating that the first target object is to be set as a cleaning target object, and thereafter, causing a display included in the autonomous mobile cleaning apparatus to display a first display screen that allows selection of a first movement mode or a second movement mode. The autonomous mobile cleaning apparatus is caused to climb over the first target object in a first process, the autonomous mobile cleaning apparatus is caused to clean a first area except for the first target object in a second process, the second process is performed prior to the first process in the first movement mode, and the first process is performed prior to the second process in the second movement mode.

This program may be downloaded from, for example, a server and executed, or may be recorded to a predetermined recording medium (for example, an optical disk or a magnetic disk, such as a CD-ROM, or a semiconductor memory), read from the recording medium, and executed.

The program may be executed by a single computer or plural computers. That is, central processing or distributed processing may be performed.

Any of the embodiments or modifications described above can be combined as appropriate to produce the effects of each of the combined embodiments or modifications. Embodiments can be combined, examples can be combined, or any embodiment and any example can be combined. Further, features in different embodiments or different examples can be combined.

The autonomous mobile cleaning apparatus, the cleaning method that is performed by the autonomous mobile cleaning apparatus, and the program for the autonomous mobile cleaning apparatus according to the present disclosure are applicable to autonomous mobile cleaning apparatuses, cleaning methods that are performed by autonomous mobile cleaning apparatuses, and programs for autonomous mobile cleaning apparatuses that are used in various environments in addition to autonomous mobile cleaning apparatuses for home use and autonomous mobile cleaning apparatuses for professional use.

What is claimed is:

1. An autonomous mobile cleaning apparatus comprising:
a main body;
a suction unit included in the main body;
a driver included in the main body and driving movement of the main body;
a controller included in the main body; and
a display included in the main body, wherein
(a) the controller obtains information about a first target object having a possibility of putting the main body into a stuck state, and
(b) the controller accepts information indicating that the first target object is to be set as a cleaning target object, and thereafter, causes the display to display a first display screen that allows selection of a first movement mode or a second movement mode,
the autonomous mobile cleaning apparatus is caused to climb over the first target object in a first process,
the autonomous mobile cleaning apparatus is caused to clean a first area except for the first target object in a second process,
the second process is performed prior to the first process in the first movement mode, and
the first process is performed prior to the second process in the second movement mode.

2. The autonomous mobile cleaning apparatus according to claim 1, further comprising
a memory that stores the information about the first target object, wherein
the controller obtains the information about the first target object from the memory.

3. The autonomous mobile cleaning apparatus according to claim 1, wherein
(c) after obtaining the information about the first target object and before accepting the information indicating that the first target object is to be set as a cleaning target object, the controller causes the display to display a second display screen that allows selection of whether to set the first target object as a cleaning target object, and
in a state where the second display screen is displayed, the controller accepts information indicating that the first target object is to be set or is not to be set as a cleaning target object.

4. The autonomous mobile cleaning apparatus according to claim 1, wherein
(d1) in a case where the controller accepts selection of the first movement mode in a state where the first display screen is displayed, the controller causes the main body to move in accordance with the first movement mode, and
(d2) in a case where the controller accepts selection of the second movement mode in a state where the first display screen is displayed, the controller causes the main body to move in accordance with the second movement mode.

5. The autonomous mobile cleaning apparatus according to claim 1, further comprising
a camera included in the main body, wherein
the camera obtains a camera image including information about surrounding of the main body, and
in (a), the controller obtains the information about the first target object on the basis of the camera image.

6. The autonomous mobile cleaning apparatus according to claim 1, further comprising
a first sensor included in the main body, wherein
in (a), the controller obtains the information about the first target object on the basis of information about objects detected by the first sensor.

7. The autonomous mobile cleaning apparatus according to claim 1, further comprising
a second sensor that detects the stuck state, wherein
in (a), the controller obtains the information about the first target object on the basis of information about the stuck state detected by the second sensor.

8. The autonomous mobile cleaning apparatus according to claim 1, further comprising
a second sensor that detects the stuck state, wherein
(e1) the controller controls the driver to drive the main body on the basis of selection of the second movement mode, and
(e2) in a case where the second sensor detects the stuck state, and thereafter, the controller detects the main body exiting the stuck state, the controller changes the second movement mode to the first movement mode and controls the driver to drive the main body.

9. The autonomous mobile cleaning apparatus according to claim 1, further comprising
a second sensor that detects the stuck state, wherein
(e1) the controller controls the driver to drive the main body on the basis of selection of the second movement mode, and
(e2) in a case where the second sensor detects the stuck state, and thereafter, the controller detects the main body exiting the stuck state, the controller causes the display to display the first display screen.

10. The autonomous mobile cleaning apparatus according to claim 1, further comprising
a second sensor that detects the stuck state, wherein
(f1) the controller accepts selection of the second movement mode in a state where the first display screen is displayed,
(f2) the controller selects one operation control mode from among operation control modes as a first operation control mode and controls the driver in accordance with the first operation control mode and the second movement mode to drive the main body, and
(f3) in a case where the second sensor detects the stuck state, and thereafter, the controller detects the main body exiting the stuck state, the controller selects an operation control mode different from the first operation control mode as a second operation control mode from among the operation control modes and controls the driver in accordance with the second operation control mode and the second movement mode to drive the main body, and
the second operation control mode is different from the first operation control mode in a movement speed, a movement direction, or rotation or stop of a side brush of the main body.

11. The autonomous mobile cleaning apparatus according to claim 10, wherein
(f4) in a case where the controller drives the main body in accordance with the second operation control mode and the second movement mode, and thereafter, the second sensor detects the stuck state, the controller changes the second movement mode to the first movement mode and controls the driver to drive the main body.

12. A cleaning method for an autonomous mobile cleaning apparatus, the method comprising:
(a) obtaining information about a first target object having a possibility of putting a main body included in the autonomous mobile cleaning apparatus into a stuck state, the main body including a suction unit; and
(b) accepting information indicating that the first target object is to be set as a cleaning target object, and thereafter, causing a display included in the autonomous mobile cleaning apparatus to display a first display screen that allows selection of a first movement mode or a second movement mode, wherein
the autonomous mobile cleaning apparatus is caused to climb over the first target object in a first process,
the autonomous mobile cleaning apparatus is caused to clean a first area except for the first target object in a second process,
the second process is performed prior to the first process in the first movement mode, and
the first process is performed prior to the second process in the second movement mode.

13. The cleaning method according to claim 12, wherein
the information about the first target object is obtained from a memory included in the autonomous mobile cleaning apparatus.

14. The cleaning method according to claim 12, further comprising
(c) after obtaining the information about the first target object and before accepting the information indicating that the first target object is to be set as a cleaning target object, causing the display to display a second display screen that allows selection of whether to set the first target object as a cleaning target object, wherein
in a state where the second display screen is displayed, information indicating that the first target object is to be set or is not to be set as a cleaning target object is accepted.

15. The cleaning method according to claim 12, further comprising:
(d1) in a case of accepting selection of the first movement mode in a state where the first display screen is displayed, moving the main body in accordance with the first movement mode; and
(d2) in a case of accepting selection of the second movement mode in a state where the first display screen is displayed, moving the main body in accordance with the second movement mode.

16. The cleaning method according to claim 12, wherein
in (a), the information about the first target object is obtained on the basis of a camera image obtained by a camera included in the main body.

17. The cleaning method according to claim 12, wherein
in (a), the information about the first target object is obtained on the basis of information about objects detected by a first sensor included in the main body.

18. The cleaning method according to claim 12, wherein
in (a), the information about the first target object is obtained on the basis of information about the stuck state detected by a second sensor that detects the stuck state.

19. The cleaning method according to claim 12, further comprising:
(e1) controlling a driver to drive the main body on the basis of selection of the second movement mode, the driver being included in the main body and driving movement of the main body; and
(e2) in a case of detecting the main body exiting the stuck state after detection of the stuck state by a second sensor, changing the second movement mode to the first movement mode and controlling the driver to drive the main body, the second sensor being included in the autonomous mobile cleaning apparatus and detecting the stuck state.

20. The cleaning method according to claim 12, further comprising:
(e1) controlling a driver to drive the main body on the basis of selection of the second movement mode, the driver being included in the main body and driving movement of the main body; and
(e2) in a case of detecting the main body exiting the stuck state after detection of the stuck state by a second sensor, causing the display to display the first display screen, the second sensor being included in the autonomous mobile cleaning apparatus and detecting the stuck state.

21. The cleaning method according to claim 12, further comprising:
(f1) accepting selection of the second movement mode in a state where the first display screen is displayed;
(f2) selecting one operation control mode from among operation control modes as a first operation control mode and controlling a driver on the basis of the first operation control mode and the second movement mode to drive the main body, the driver being included in the main body and driving movement of the main body; and
(f3) in a case of detecting the main body exiting the stuck state after detection of the stuck state by a second sensor, selecting an operation control mode different from the first operation control mode as a second operation control mode from among the operation control modes and controlling the driver in accordance with the second operation control mode and the second movement mode to drive the main body, the second sensor being included in the autonomous mobile cleaning apparatus and detecting the stuck state, wherein
the second operation control mode is different from the first operation control mode in a movement speed, a movement direction, or rotation or stop of a side brush of the main body.

22. The cleaning method according to claim 21, further comprising
(f4) in a case of detection of the stuck state by the second sensor after driving the main body in accordance with the second operation control mode and the second movement mode, changing the second movement mode to the first movement mode and controlling the driver to drive the main body.

23. A non-transitory computer-readable recording medium storing a program for causing a device including a processor to execute processing, the processing being a cleaning method for an autonomous mobile cleaning apparatus, the method comprising:
(a) obtaining information about a first target object having a possibility of putting a main body included in the autonomous mobile cleaning apparatus into a stuck state, the main body including a suction unit; and
(b) accepting information indicating that the first target object is to be set as a cleaning target object, and thereafter, causing a display included in the autonomous mobile cleaning apparatus to display a first display screen that allows selection of a first movement mode or a second movement mode, wherein
the autonomous mobile cleaning apparatus is caused to climb over the first target object in a first process,
the autonomous mobile cleaning apparatus is caused to clean a first area except for the first target object in a second process,
the second process is performed prior to the first process in the first movement mode, and
the first process is performed prior to the second process in the second movement mode.
